(19) United States
(12) Patent Application Publication
(10) Pub. No.: US 2020/0263029 A1
(43) Pub. Date: Aug. 20, 2020

(54) RESIN COMPOSITION, ELECTROPHOTOGRAPHIC PHOTOSENSITIVE MATERIAL, AND ELECTROPHOTOGRAPHIC DEVICE

(71) Applicant: IDEMITSU KOSAN CO., LTD., Tokyo (JP)

(72) Inventors: Kengo HIRATA, Chiba (JP); Takaaki HIKOSAKA, Chiba (JP)

(73) Assignee: IDEMITSU KOSAN CO., LTD., Tokyo (JP)

(21) Appl. No.: 16/304,951

(22) PCT Filed: May 26, 2017
(86) PCT No.: PCT/JP2017/019753

§ 371 Date: Nov. 27, 2018

(30) Foreign Application Priority Data
May 27, 2016 (JP) 2016-106846

(51) Int. Cl. C08L 69/00; C08G 64/06; G03G 5/05; G03G 5/047

(52) U.S. Cl. CPC C08L 69/00; G03G 5/047; G03G 5/0564; C08G 64/06

(57) ABSTRACT

A resin composition includes: a polycarbonate copolymer resin represented by a formula (1); and a polycarbonate resin having a repeating unit represented by a formula (2). Provided that a total of the polycarbonate copolymer resin represented by the formula (1) and the polycarbonate resin having the repeating unit represented by the formula (2) is defined as 100 parts by mass, a content of the polycarbonate copolymer resin represented by the formula (1) is in a range from 50 parts by mass to 95 parts by mass,

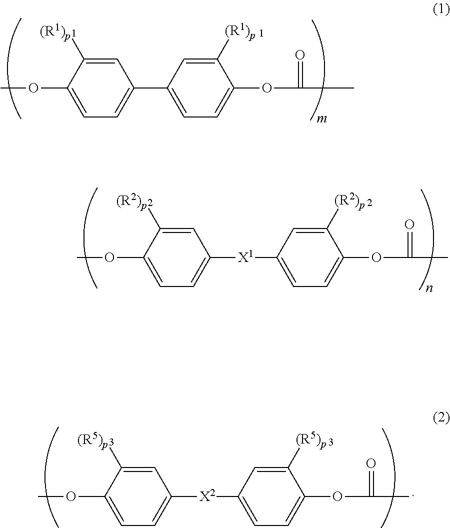

### TECHNICAL FIELD

The present invention relates to a resin composition, an electrophotographic photoreceptor, and an electrophotographic device.

### BACKGROUND ART

A polycarbonate resin has been used as a material for molded products in various industrial fields because of its excellent mechanical characteristics, thermal characteristics, electrical characteristics and the like. Recently, the polycarbonate resin has often been used in a field of a functional product requiring optical characteristics of the polycarbonate resin as well as the above characteristics. In accordance with such an expansion in application, the polycarbonate resin has been demanded to have a variety of performance. A typical polycarbonate resin made from 2,2-bis(4-hydroxyphenyl)propane, 1,1-bis(4-hydroxyphenyl)cyclohexane and the like is sometimes insufficient to satisfy the above demand. For this reason, polycarbonate resins having various chemical structures have been proposed depending on an intended use and a required performance.

### CITATION LIST

### Patent Literatures

Patent Literature 1 JP Patent No. 5886825

Patent Literature 2 JP Patent No. 5349709

Patent Literature 3 JP Patent No. 5731146

Patent Literature 4 JP 4-179961 A

### SUMMARY OF THE INVENTION

### Problems to be Solved by the Invention

Such a functional product is exemplified by an electrophotographic photoreceptor in which a polycarbonate resin is used as a binder resin for a functional material such as a charge generating material and a charge transporting material.

The electrophotographic photoreceptor has been demanded to have a predetermined sensitivity, electrical characteristics and optical characteristics depending on an electrophotography process to which the electrophotographic photoreceptor is applied. A surface of a photosensitive layer of the electrophotographic photoreceptor is repeatedly subjected to operations such as corona electrification, toner development, transfer onto paper, cleaning and the like. Electrical and mechanical external-forces are applied on the surface of the photosensitive layer every time such operations are performed. Consequently, the photosensitive layer (surface layer) of the electrophotographic photoreceptor is required to have durability against these external forces in order to maintain electrophotography image quality for a long period of time.

One way for improving durability of the electrophotographic photoreceptor is considered to select the binder resin used in an outermost layer of the electrophotographic photoreceptor. A polycarbonate resin made from 2,2-bis(4-hydroxyphenyl)propane, 1,1-bis(4-hydroxyphenyl)cyclohexane and the like has been typically used as the binder resin for the photoreceptor, but is insufficient to satisfy durability of the electrophotographic photoreceptor. In view of the above, various techniques have been used in response to such demands. In order to effectively improve wear resistance of the photosensitive layer, it has been known to use a polycarbonate copolymer.

For instance, Patent Literature 4 discloses a polycarbonate copolymer of bisphenol Z and biphenol, the polycarbonate copolymer exhibiting a superior wear resistance to bis-Z polycarbonate.

Moreover, Patent Literature 2 discloses “an alternating polycarbonate copolymer of bisphenol Z and biphenol “(a copolymerization ratio=40%).”

Recently, Patent Literature 1 discloses “a polycarbonate having high contents of biphenol and dimethylbiphenol” as a polymer having an improved copolymerization ratio of biphenol exhibiting a favorable wear resistance (a copolymerization ratio of biphenol=50 to 65%). Moreover, Patent Literature 3 discloses “a polycarbonate having a high content of dimethylbiphenol” (a copolymerization ratio of dimethylbiphenol=39 to 58%).

However, even these resins exhibit an insufficient wear resistance.

Moreover, the electrophotographic photoreceptor containing these resins also exhibits an insufficient wear resistance. Further, the electrophotographic photoreceptor containing the resin disclosed in Patent Literature 3 also exhibits insufficient electrical characteristics.

An object of the invention is to provide a resin composition exhibiting an improved wear resistance as compared with a typical resin composition, an electrophotographic photoreceptor exhibiting an excellent wear resistance and satisfactory electrical characteristics, and an electrophotographic device using the electrophotographic photoreceptor.

### Means for Solving the Problems

According to an aspect of the invention, a resin composition includes: a polycarbonate copolymer resin represented by a formula (1); and a polycarbonate resin having a repeating unit represented by a formula (2), in which, provided that a total of the polycarbonate copolymer resin represented by the formula (1) and the polycarbonate resin having the repeating unit represented by the formula (2) is defined as 100 parts by mass, a content of the polycarbonate copolymer resin represented by the formula (1) is in a range from 50 parts by mass to 95 parts by mass.

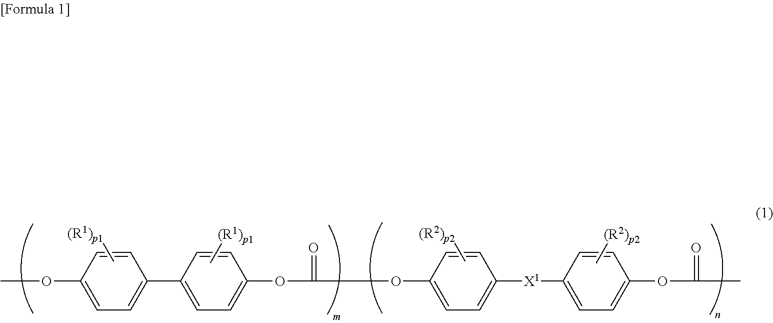

In the formula (1), m and n each represent an average repeating number of a skeleton unit. A molar copolymer composition represented by m/(m+n) ranges from 0.4 to 0.67.

In the formula (1), X¹ is selected from the group consisting of —O—, —CR³R⁴—, and a substituted or unsubstituted cycloalkylidene group having 5 to 12 carbon atoms.

When a plurality of X¹ are present, the plurality of X¹ are mutually the same group or different groups.

R¹ and R² are each independently an alkyl group having 1 to 3 carbon atoms or perfluoroalkyl group having 1 to 3 carbon atoms.

A plurality of R¹ are mutually the same group or different groups.

When a plurality of R² are present, the plurality of R² are mutually the same group or different groups.

R³ and R⁴ are each independently selected from the group consisting of a hydrogen atom, an alkyl group having 1 to 12 carbon atoms, and a trifluoromethyl group.

When a plurality of R³ are present, the plurality of R³ are mutually the same group or different groups.

When a plurality of R⁴ are present, the plurality of R⁴ are mutually the same group or different groups.

p¹ is 1 or 2. A plurality of p¹ are mutually the same or different.

p² is an integer of 0 to 2. A plurality of p² are mutually the same or different,

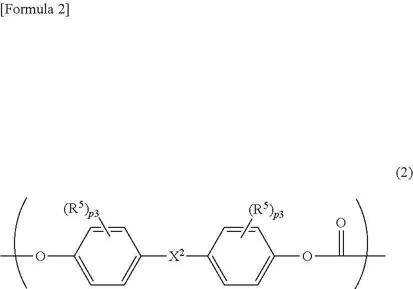

In the formula (2), X² is —CR⁶R⁷—.

R⁵ is an alkyl group having 1 to 3 carbon atoms. When a plurality of R⁵ are present, the plurality of R⁵ are mutually the same group or different groups.

R⁶ and R⁷ are each independently selected from the group consisting of a hydrogen atom, an alkyl group having 1 to 12 carbon atoms, a trifluoromethyl group, and a substituted or unsubstituted aryl group having 6 to 12 ring carbon atoms.

p³ is an integer of 0 to 2. A plurality of p³ are mutually the same or different.

According to another aspect of the invention, a resin composition includes: a polycarbonate copolymer resin represented by a formula (1); and a polyarylate resin having a repeating unit represented by a formula (3), in which, provided that a total of the polycarbonate copolymer resin represented by the formula (1) and the polyarylate resin having the repeating unit represented by the formula (3) is defined as 100 parts by mass, a content of the polycarbonate copolymer resin represented by the formula (1) is in a range from 50 parts by mass to 95 parts by mass.

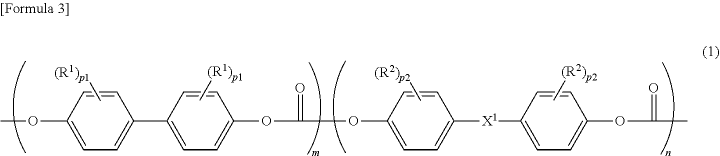

In the formula (1), m and n each represent an average repeating number of a skeleton unit. A molar copolymer composition represented by m/(m+n) ranges from 0.4 to 0.67.

In the formula (1), X¹ is selected from the group consisting of —O—, —CR³R⁴—, and a substituted or unsubstituted cycloalkylidene group having 5 to 12 carbon atoms.

When a plurality of X¹ are present, the plurality of X¹ are mutually the same group or different groups.

R¹ and R² are each independently an alkyl group having 1 to 3 carbon atoms or perfluoroalkyl group having 1 to 3 carbon atoms.

A plurality of R¹ are mutually the same group or different groups.

When a plurality of R² are present, the plurality of R² are mutually the same group or different groups.

R³ and R⁴ are each independently selected from the group consisting of a hydrogen atom, an alkyl group having 1 to 12 carbon atoms, and a trifluoromethyl group.

When a plurality of R³ are present, the plurality of R³ are mutually the same group or different groups.

When a plurality of R⁴ are present, the plurality of R⁴ are mutually the same group or different groups.

p¹ is 1 or 2. A plurality of p¹ are mutually the same or different.

p² is an integer of 0 to 2. A plurality of p² are mutually the same or different.

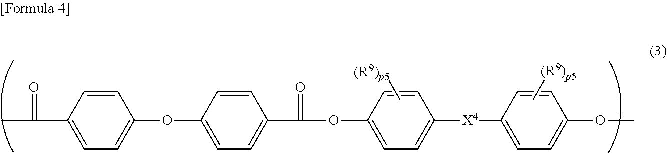

In the formula (3), X⁴ is selected from the group consisting of a single bond, —CR¹⁰R¹¹—, and a substituted or unsubstituted cycloalkylidene group having 5 to 12 carbon atoms.

R⁹ is an alkyl group having 1 to 3 carbon atoms. When a plurality of R⁹ are present, the plurality of R⁹ are mutually the same group or different groups.

R¹⁰ and R¹¹ are each independently selected from the group consisting of a hydrogen atom, an alkyl group having 1 to 12 carbon atoms, a trifluoromethyl group, and a substituted or unsubstituted aryl group having 6 to 12 ring carbon atoms.

p⁵ is an integer of 0 to 2. A plurality of p⁵ are mutually the same or different.

According to a still another aspect of the invention, an electrophotographic photoreceptor includes: a conductive substrate; and a photosensitive layer formed on the conductive substrate, in which the photosensitive layer contains the resin composition according to the above aspect of the invention as a component.

According to a further aspect of the invention, an electrophotographic device includes the electrophotographic photoreceptor according to the above aspect of the invention

According to the above aspects of the invention, a resin composition exhibiting an improved wear resistance as compared with a typical resin composition, an electrophotographic photoreceptor exhibiting an excellent wear resistance and satisfactory electrical characteristics, and an electrophotographic device using the electrophotographic photoreceptor can be provided.

### DESCRIPTION OF EMBODIMENT(S)

A resin composition, an electrophotographic photoreceptor, and an electrophotographic device according to exemplary embodiments of the invention will be described in detail.

### First Exemplary Embodiment

### Resin Composition

A resin composition according to a first exemplary embodiment contains a polycarbonate copolymer resin represented by a formula (1) and a polycarbonate resin having a repeating unit represented by a formula (2). Provided that a total of the polycarbonate copolymer resin represented by the formula (1) and the polycarbonate resin having the repeating unit represented by the formula (2) is defined as 100 parts by mass, a content of the polycarbonate copolymer resin represented by the formula (1) is in a range from 50 parts by mass to 95 parts by mass.

A mechanical strength of the resin composition is improved when the content of the polycarbonate copolymer resin represented by the formula (1) is 95 parts by mass or less. The mechanical strength of the resin composition is equivalent to or more than a mechanical strength of the polycarbonate copolymer resin when the content of the polycarbonate copolymer resin represented by the formula (1) is 50 parts by mass or more.

Provided that the total of the polycarbonate copolymer resin represented by the formula (1) and the polycarbonate resin having the repeating unit represented by the formula (2) is defined as 100 parts by mass, the content of the polycarbonate copolymer resin represented by the formula (1) is preferably in a range from 70 parts by mass to 95 parts by mass, more preferably in a range from 80 parts by mass to 95 parts by mass.

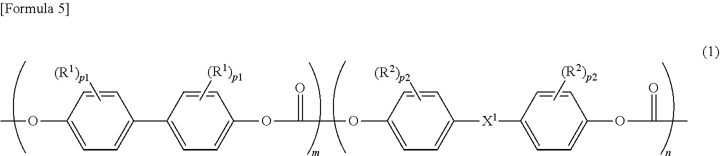

In the formula (1), m and n each represent an average repeating number of a skeleton unit. A molar copolymer composition represented by m/(m+n) ranges from 0.4 to 0.67.

The resin composition exhibits sufficient wear resistance, hardness and gas barrier property at 0.4 or more of the molar copolymer composition represented by m/(m+n). Moreover, when the molar copolymer composition represented by m/(m+n) is 0.67 or less, the polycarbonate copolymer resin represented by the formula (1) (hereinafter, “polycarbonate” is occasionally abbreviated as “PC”) exhibits an improved solubility in a solvent, especially, a non-halogen solvent.

In the formula (1), X¹ is selected from the group consisting of —O—, —CR³R⁴—, and a substituted or unsubstituted cycloalkylidene group having 5 to 12 carbon atoms.

When a plurality of X¹ are present, the plurality of X¹ are mutually the same group or different groups.

R¹ and R² are each independently an alkyl group having 1 to 3 carbon atoms or perfluoroalkyl group having 1 to 3 carbon atoms.

A plurality of R¹ are mutually the same group or different groups.

When a plurality of R² are present, the plurality of R² are mutually the same group or different groups.

R³ and R⁴ are each independently selected from the group consisting of a hydrogen atom, an alkyl group having 1 to 12 carbon atoms, and a trifluoromethyl group.

When a plurality of R³ are present, the plurality of R³ are mutually the same group or different groups.

When a plurality of R⁴ are present, the plurality of R⁴ are mutually the same group or different groups.

p¹ is 1 or 2. A plurality of p¹ are mutually the same or different.

p² is an integer of 0 to 2. A plurality of p² are mutually the same or different.

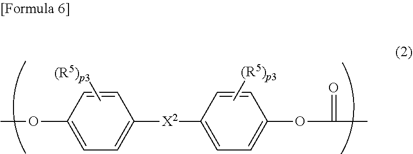

In the formula (2), X² is —CR⁶R⁷—.

R⁵ is an alkyl group having 1 to 3 carbon atoms. When a plurality of R⁵ are present, the plurality of R⁵ are mutually the same group or different groups.

R⁶ and R⁷ are each independently selected from the group consisting of a hydrogen atom, an alkyl group having 1 to 12 carbon atoms, a trifluoromethyl group, and a substituted or unsubstituted aryl group having 6 to 12 ring carbon atoms.

p³ is an integer of 0 to 2. A plurality of p³ are mutually the same or different.

In the exemplary embodiment, the polycarbonate resin having the repeating unit represented by the formula (2) is preferably a polycarbonate copolymer resin represented by a formula (20).

Since the polycarbonate copolymer resin represented by the formula (20) includes a skeleton having an excellent solubility and a skeleton having an excellent wear resistance, the polycarbonate copolymer resin represented by the formula (20) is excellent in having both characteristics of the skeletons.

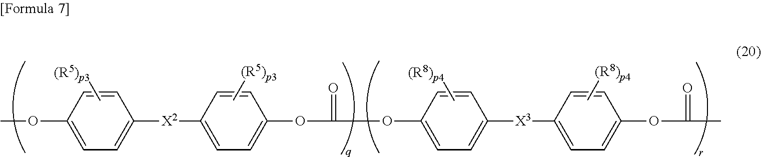

In the formula (20), q and r each represent an average repeating number of a skeleton unit. A molar copolymer composition represented by q/(q+r) ranges from 0.1 to 0.9.

When the molar copolymer composition represented by q/(q+r) is 0.1 or more, the PC copolymer resin represented by the formula (20) exhibits a sufficient solubility. When the molar copolymer composition represented by q/(q+r) is 0.9 or less, the PC copolymer resin represented by the formula (20) exhibits an improved wear resistance.

In the formula (20), X², R⁵ and p³ respectively represent the same as X², R⁵ and p³ in the formula (2).

When a plurality of X² are present, the plurality of X² are mutually the same group or different groups.

X³ is a single bond or —O—. When a plurality of X³ are present, the plurality of X³ are mutually the same or different.

R⁸ is an alkyl group having 1 to 3 carbon atoms. When a plurality of R⁸ are present, the plurality of R⁸ are mutually the same group or different groups.

p⁴ is an integer of 0 to 2. A plurality of p⁴ are mutually the same or different.

In the exemplary embodiment, the polycarbonate copolymer resin represented by the formula (1) is preferably one polycarbonate copolymer resin selected from the group consisting of a polycarbonate copolymer resin represented by a formula (1-1), a polycarbonate copolymer resin represented by a formula (1-2), and a polycarbonate copolymer resin represented by a formula (1-3).

The polycarbonate copolymer resins represented by the formulae (1-1) to (1-3) each include: a 3,3′-dimethyl-4,4′-dihydroxybiphenyl skeleton that contributes to wear resistance and hardness; and one of a 1,1-bis(3-methyl-4-hydroxyphenyl)cyclohexane skeleton, a 1,1-bis(4-hydroxyphenyl)cyclohexane skeleton, and a 2,2-bis(3-methyl-4-hydroxyphenyl)propane skeleton, which contribute to hardness and gas barrier property. The polycarbonate copolymer resins represented by the formulae (1-1) to (1-3) are excellent in having both characteristics of the skeletons.

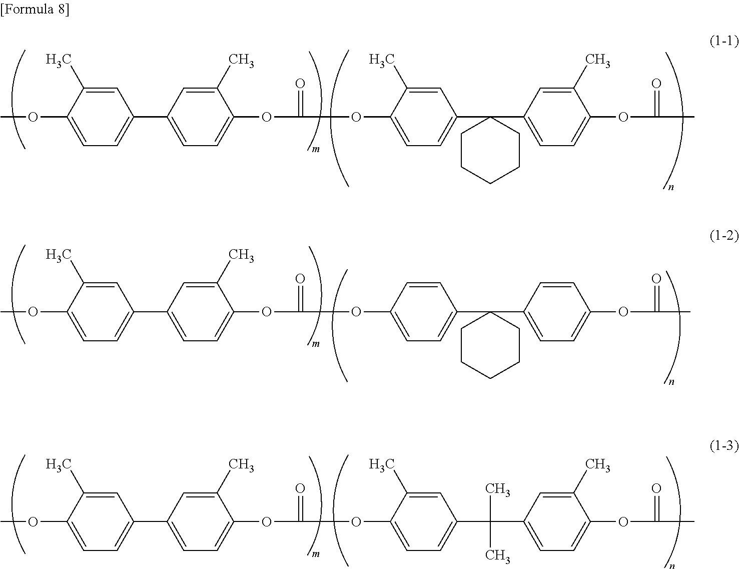

m and n in the formulae (1-1) to (1-3) respectively represent the same as m and n in the formula (1).

A reduced viscosity [η_{SP}/C] at 20 degrees C. of the resin (in a solution in which the resin is dissolved at a concentration of 0.5 g/dL in methylene chloride (solvent)) forming the resin composition in the exemplary embodiment is preferably in a range from 0.2 dL/g to 5 dL/g, more preferably from 0.3 dL/g to 3 dL/g, further preferably from 0.4 dL/g to 2.5 dL/g. The reduced viscosity can be measured by a method described later in Examples.

When the reduced viscosity [η_{SP}/C] is 0.2 dL/g or more, the electrophotographic photoreceptor containing the resin exhibits a sufficient wear resistance. When the reduced viscosity [η_{SP}/C] is 5 dL/g or less, a coating viscosity of a coating liquid containing the resin and used for manufacturing a molded product (e.g., the electrophotographic photoreceptor) is not excessively high, so that productivity of the molded product (e.g., the electrophotographic photoreceptor) is improved.

### Manufacturing Method of Resin Composition

The resin composition in the exemplary embodiment can be manufactured by mixing the polycarbonate copolymer resin represented by the formula (1) (hereinafter, also referred to as a “PC copolymer resin (1)”) and the polycarbonate resin represented by the formula (2) (hereinafter, also referred to as a “PC resin (2)) at a mass ratio between the “PC copolymer resin (1)”:the “PC resin (2) in a range from 50 parts by mass: 50 parts by mass to 95 parts by mass: 5 parts by mass.

### Manufacturing Method of PC Resin

The PC resin in the exemplary embodiment can be easily obtained in a form of flake powder by conducting a polycondensation reaction using a mixture monomer in which a monomer represented by a formula (10) and a monomer represented by a formula (11) are mixed together.

[Formula 9]

HO—Ar¹—OH (10)

HO—Ar²—OH (11)

In the formula (10), Ar¹ represents a divalent aromatic group.

In the formula (11), Ar² represents a divalent aromatic group.

For instance, in manufacturing the PC copolymer resin (1), Ar¹ in the formula (10) is a group represented by a formula (10A) and Ar² in the formula (11) is a group represented by a formula (11A).

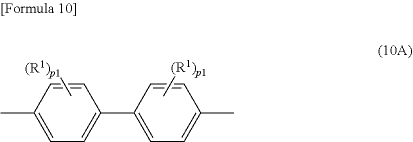

In the formula (10A), R¹ is an alkyl group having 1 to 3 carbon atoms or a perfluoroalkyl group having 1 to 3 carbon atoms. When a plurality of R¹ are present, the plurality of R¹ are mutually the same group or different groups. p¹ is 1 or 2. A plurality of p¹ are mutually the same or different.

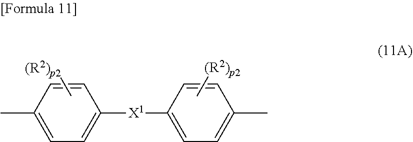

In the formula (11A), X¹ is selected from the group consisting of —O—, —CR³R⁴—, and a substituted or unsubstituted cycloalkylidene group having 5 to 12 carbon atoms. R² is an alkyl group having 1 to 3 carbon atoms or a perfluoroalkyl group having 1 to 3 carbon atoms. When a plurality of R² are present, the plurality of R² are mutually the same group or different groups. R³ and R⁴ are each independently selected from the group consisting of a hydrogen atom, an alkyl group having 1 to 12 carbon atoms, and a trifluoromethyl group. p² is an integer of 0 to 2. A plurality of p² are mutually the same or different.

When Ar¹ is the group represented by the formula (10A), examples of the bisphenol compound represented by the formula (10) include 3,3′-dimethyl-4,4′-dihydroxybiphenyl, 3,3′-diethyl-4,4′-dihydroxybiphenyl, and 3,3′,5,5′-tetramethyl-4,4′-dihydroxybiphenyl.

Among the examples, 3,3′-dimethyl-4,4′-dihydroxybiphenyl is preferable in terms of imparting an excellent wear resistance to the resin composition. Moreover, use of the resin composition in the exemplary embodiment for the electrophotographic photoreceptor also improves durability of the electrophotographic photoreceptor.

One of the monomer represented by the formula (10) (i.e., the bisphenol compound) may be used alone, or two or more thereof may be used in combination.

When Ar² is a group represented by the formula (11A), examples of the bisphenol compound represented by the formula (11) include bis(4-hydroxyphenyl)ether, 2,2-bis(4-hydroxyphenyl)propane, 2,2-bis(4-hydroxyphenyl)butane, 2,2-bis(4-hydroxyphenyl)pentane, 1,1-bis(4-hydroxyphenyl)ethane, 1,1-bis(4-hydroxyphenyl)propane, 1,1-bis(4-hydroxyphenyl)butane, 3,3-bis(4-hydroxyphenyl)hexane, 4,4-bis(4-hydroxyphenyl)heptane, 1,1-bis(4-hydroxyphenyl)cyclohexane, 1,1-bis(4-hydroxyphenyl)cyclopentane, 2,2-bis(3-methyl-4-hydroxyphenyl)propane, 1,1-bis(4-hydroxyphenyl)-3-methylcyclohexane, 1,1-bis(3-methyl-4-hydroxyphenyl)cyclohexane, 1,1-bis(3-methyl-4-hydroxyphenyl)-3-methylcyclohexane, bis(3-methyl-4-hydroxyphenyl)ether, and bis(3-ethyl-4-hydroxyphenyl)ether.

Among the above dihydric phenol compound, bis(4-hydroxyphenyl)ether, 1,1-bis(4-hydroxyphenyl)cyclohexane, 1,1-bis(3-methyl-4-hydroxyphenyl)cyclohexane, and 2,2-bis(3-methyl-4-hydroxyphenyl)propane are preferable in terms of imparting excellent wear resistance and solubility to the PC copolymer resin (1). The above-exemplified PC copolymer resin (1) is preferable since, when the PC copolymer resin (1) is applied to the electrophotographic photoreceptor, the electrophotographic photoreceptor is unlikely to be worn by friction against another member in a cleaning process and the like, resulting in improving durability.

One of the monomer represented by the formula (11) (i.e., the bisphenol compound) may be used alone, or two or more thereof may be used in combination. Moreover, a trihydric or polyhydric phenol may be used to provide a branched structure to the monomer represented by the formula (11).

The PC copolymer resin (1) forming the resin composition of the exemplary embodiment is easily obtainable by conducting a polycondensation reaction (e.g., interfacial polycondensation) using the monomer represented by the formula (10) and the monomer represented by the formula (11).

For instance, by conducting interfacial polycondensation under the presence of an acid-binding agent with use of various carbonyl dihalides (e.g., phosgene), halo formates (e.g., chloroformate compounds), a carbonate ester compound and the like, carbonate ester bonding can be favorably formed.

Alternatively, interesterification is applicable.

The above reaction(s) is conducted as needed under the presence of at least one of a terminal terminator or a branching agent.

In the manufacturing method of the PC copolymer resin (1) forming the resin composition of the exemplary embodiment, monohydric phenol, fluorine-containing alcohol and the like are usable as a terminal terminator for forming a chain end.

Preferable examples of the fluorine-containing alcohol include fluorine-containing alcohol represented by a formula (30) or (31) below and 1,1,1,3,3,3-hexafluoro-2-propanol. Moreover, fluorine-containing alcohol with an ether bond represented by a formula (14), (15) or (16) below is also preferably used.

H(CF₂)ₛCH₂OH (30)

F(CF₂)ₜCH₂OH (31)

In the formula (30), s is an integer of 1 to 12. In the formula (31), t is an integer of 1 to 12.

[Formula 12]

F—(CF₂)ₙ³¹—OCF₂CH₂—OH (14)

F—(CF₂CF₂)ₙ³²—(CF₂CF₂FO)ₙ³³—CF₂CH₂—OH (15)

C(R)₃—(CF₂)ₙ³⁵—O—(CF₂CF₂O)ₙ³⁴—CF₂CH₂—OH (16)

In the formula (14), n³¹ is an integer of 1 to 10, preferably an integer of 5 to 8.

In the formula (15), n³² is an integer of 0 to 5, preferably an integer of 0 to 3 and n³³ is an integer of 1 to 5, preferably an integer of 1 to 3.

In the formula (16), n³⁴ is an integer of 1 to 5, preferably an integer of 1 to 3, n³⁵ is an integer of 0 to 5, preferably an integer of 0 to 3, and R is CF₃ or F.

In order to improve the electrical characteristics and the wear resistance, the chain end is preferably terminated by a monohydric phenol represented by a formula (5) below or a monohydric fluorine-containing alcohol represented by a formula (6) below among the above examples of the terminal terminator.

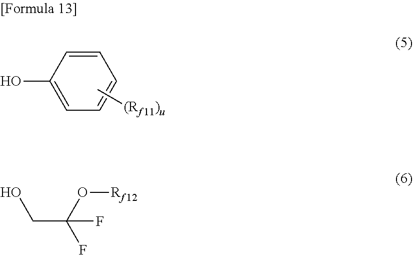

In the formula (5), R_{f11} is a group selected from the group consisting of an alkyl group having 1 to 10 carbon atoms and a fluoroalkyl group having 1 to 10 carbon atoms. When a plurality of R_{f11} are present, the plurality of R_{f11} are the same group or different groups. u is an integer of 1 to 3.

In the formula (6), R_{f12} is a group selected from the group consisting of a perfluoroalkyl group having at least 5 carbon atoms and having at least 11 fluorine atoms, and a perfluoroalkyloxy group represented by the formula (7) below.

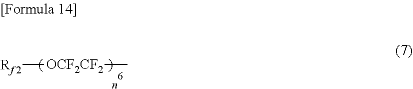

In the formula (7), R_{f2} is a linear or branched perfluoroalkyl group having 1 to 6 carbon atoms. n⁶ is an integer of 1 to 3.

Examples of the monohydric phenol represented by the formula (5) include p-tert-butylphenol, p-perfluorononylphenol, p-perfluorohexylphenol, p-tert-perfluorobutylphenol, and p-perfluorooctylphenol.

Specifically, in the exemplary embodiment, the chain end is preferably terminated by the terminal terminator selected from the group consisting of p-tert-butylphenol, p-perfluorononylphenol, p-perfluorohexylphenol, p-tert-perfluorobutylphenol, and p-perfluorooctylphenol.

Examples of the above fluorine-containing alcohol represented by the formula (6) with the ether bond include compounds as follows. Specifically, the chain end in the exemplary embodiment is also preferably terminated by any one terminal terminator selected from the following fluorine-containing alcohol.

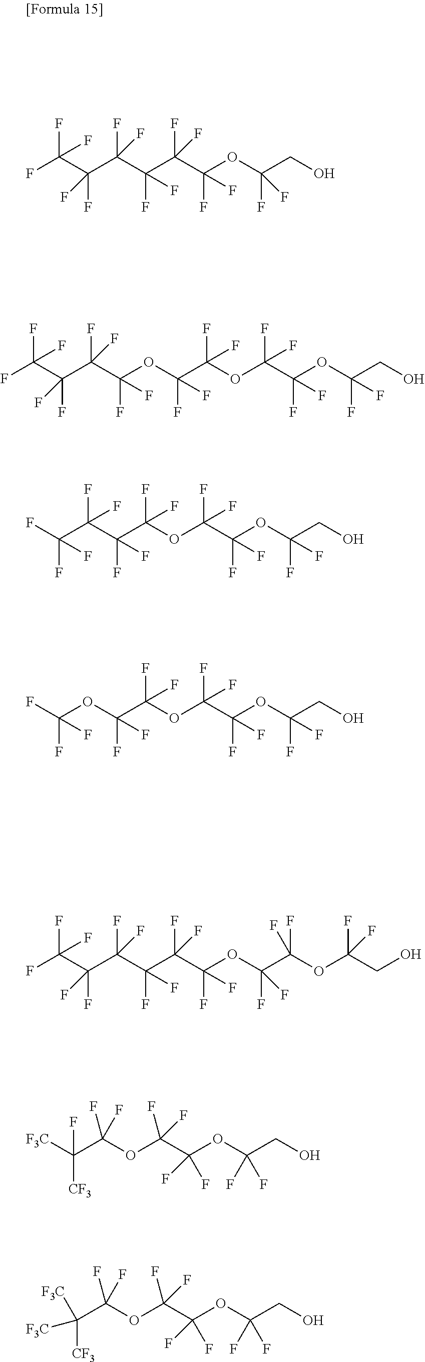

An addition ratio of the terminal terminator is preferably in a range from 0.05 mol % to 30 mol %, more preferably in a range from 0.1 mol % to 10 mol % in a mole percentage of the copolymer composition of the Ar¹ skeleton unit, the Ar² skeleton unit and the chain end. When the addition ratio of the terminal terminator is 30 mol % or less, a decrease in the mechanical strength is inhibited. When the addition ratio of the terminal terminator is 0.05 mol % or more, a decrease in molding performance is inhibited.

Examples of the branching agent usable in the manufacturing method of the PC copolymer resin (1) forming the resin composition of the exemplary embodiment include phloroglucin, pyrogallol, 4,6-dimethyl-2,4,6-tris(4-hydroxyphenyl)-2-heptene, 2,6-dimethyl-2,4,6-tris(4-hydroxyphenyl)-3-heptene, 2,4-dimethyl-2,4,6-tris(4-hydroxyphenyl)heptane, 1,3,5-tris(2-hydroxyphenyl)benzene, 1,3,5-tris(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl)cyclohexyl]propane, 2,4-bis[2-bis(4-hydroxyphenyl)-2-propyl]phenol, 2,6-bis(2-hydroxy-5-methylbenzyl)-4-methylphenol, 2-(4-hydroxyphenyl)-2-(2,4-dihydroxyphenyl)propane, tetrakis(4-hydroxyphenyl)methane, tetrakis[4-(4-hydroxyphenyl isopropyl)phenoxy]methane, 2,4-dihydroxybenzoic acid, trimesic acid, cyanuric acid, 3,3-bis(3-methyl-4-hydroxyphenyl)-2-oxo-2,3-dihydroindole, 3,3-bis(4-hydroxyaryl)oxyindole, 5-chloroisatin, 5,7-dichloroisatin and 5-bromoisatin.

An additive amount of the branching agent is preferably 30 mol % or less, more preferably 5 mol % or less in the mole percentage of the copolymer composition of the Ar¹ skeleton unit, the Ar² skeleton unit and the chain end. When the additive amount of the branching agent is 30 mol % or less, a decrease in molding performance is inhibited.

Examples of the acid-binding agent used for interfacial polycondensation include an alkali metal hydroxide, alkaline earth metal hydroxide, alkali metal weak acid salt, alkaline earth metal weak acid salt, and organic base.

Examples of the alkali metal hydroxide include sodium hydroxide, potassium hydroxide, lithium hydroxide and cesium hydroxide. Examples of the alkaline earth metal hydroxide include magnesium hydroxide and calcium hydroxide. Examples of the alkali metal weak acid salt include sodium carbonate and potassium carbonate. Examples of the alkaline earth metal weak acid salt include calcium acetate. Examples of the organic base include pyridine.

The acid-binding agent for interfacial polycondensation is preferably an alkali metal hydroxide or alkaline earth metal hydroxide, more preferably sodium hydroxide, potassium hydroxide, calcium hydroxide or the like. These acid binding agents are also usable in a mixture. A ratio of the acid-binding agent in use may be also suitably adjusted in consideration of stoichiometric proportion (equivalent amount) in the reaction. Specifically, it is only required to use 1 equivalent or more, preferably 1 equivalent to 10 equivalent of the acid-binding agent per 1 mol in the total amount of a hydroxyl group of the dihydric phenol compound (material).

A solvent used in the manufacturing method of the PC copolymer resin (1) forming the resin composition of the exemplary embodiment is only required to exhibit solubility to the obtained copolymer at a predetermined level or more. Preferable examples of the solvent include aromatic hydrocarbon, halogenated hydrocarbon, ketones, and ethers.

Examples of the aromatic hydrocarbon include toluene and xylene. Examples of the halogenated hydrocarbon include methylene chloride, chloroform, 1.1-dichloroethane, 1,2-dichloroethane, 1,1,1-trichloroethane, 1,1,2-trichloroethane, 1,1,1,2-tetrachloroethane, 1,1,2,2-tetrachloroethane, pentachloroethane and chlorobenzene. Examples of the ketones include cyclohexanone, acetone, and acetophenone. Examples of the ethers include tetrahydrofuran and 1,4-dioxane.

One of the above solvents may be used alone, or two or more thereof may be used in combination. Further, interfacial polycondensation may be conducted using two solvents that are not miscible with each other,

Preferable examples of a catalyst used in the manufacturing method of the PC copolymer resin (1) forming the resin composition of the exemplary embodiment include tertiary amine, quaternary ammonium salt and quaternary phosphonium salt.

Examples of the tertiary amine include trimethyl amine, triethylamine, tributyl amine, N,N-dimethylcyclohexyl amine, pyridine, N,N-diethyl aniline, and N,N-dimethyl aniline. Examples of the quaternary ammonium salt include trimethylbenzyl ammonium chloride, triethylbenzylammoniumchloride, tributylbenzyl ammonium chloride, trioctylmethylammoniumchloride, tetrabutyl ammonium chloride, and tetrabutyl ammonium bromide. Examples of the quaternary phosphonium salt include tetrabutyl phosphonium chloride and tetrabutyl phosphonium bromide.

Further, a small amount of an antioxidant such as sodium sulfite and hydrosulfite salt may be added as needed to the reaction system in the manufacturing method of the PC copolymer resin (1).

The manufacturing method of the PC copolymer resin (1) can be specifically implemented in various ways. The manufacturing method of the PC copolymer resin (1) is exemplified by a method including: reacting the dihydric phenol compound (at least one of the monomer represented by the formula (10) and the monomer represented by the formula (11)) with phosgene to manufacture polycarbonate oligomer; and then reacting the polycarbonate oligomer with the dihydric phenol compound under the presence of a mixture solution of the solvent and an alkali aqueous solution of the acid-binding agent. Moreover, the manufacturing method of the PC copolymer resin (1) is exemplified by a method of reacting the dihydric phenol compound with phosgene in a mixture solution of the solvent and an alkali aqueous solution.

In order to manufacture a polycarbonate oligomer, the dihydric phenol compound is initially dissolved in an alkali aqueous solution to prepare an alkali aqueous solution of the dihydric phenol compound. Subsequently, phosgene is introduced into a mixture solution of the prepared alkali aqueous solution and an organic solvent (e.g., methylene chloride) to conduct a reaction, thereby synthesizing a polycarbonate oligomer of the dihydric phenol compound. Then, the reaction solution is separated into an aqueous phase and an organic phase, so that organic phase containing the polycarbonate oligomer is obtained. At this time, alkali concentration of the alkali aqueous solution is preferably in a range of 0.1 to 5N. A volume ratio of the organic phase to the aqueous phase is in a range of 10:1 to 1:10, preferably in a range of 5:1 to 1:5.

A reaction temperature is typically in a range of 0 to 70 degrees C. under cooling operation, more preferably in a range of 5 to 65 degrees C. A reaction time is in a range of 15 minutes to 4 hours, preferably 30 minutes to 3 hours. An average molecular weight of the obtained polycarbonate oligomer is 6000 or less. A polymerization degree of the polycarbonate oligomer is typically 20 or less. The polycarbonate oligomer is preferably at most a decamer.

The manufacturing method of the polycarbonate oligomer can be implemented in various ways in order to adjust an average number of repeating units (n1), in addition to the above-described manufacturing method of bischloroformate oligomer.

For instance, a dihydric phenol compound is suspended or dissolved in a hydrophobic organic solvent to provide a suspension or a solution, and phosgene is introduced in the suspension or the solution. Into a mixture solution obtained by introducing phosgene, aliphatic tertiary amine, which is diluted with a hydrophobic organic solvent, is dropped to be reacted, thereby manufacturing a polycarbonate oligomer of the dihydric phenol compound.

The organic phase containing the obtained polycarbonate oligomer is added with the dihydric phenol compound to be reacted. The reaction temperature is preferably in a range from 0 degrees C. to 150 degrees C., more preferably in a range from 5 degrees C. to 40 degrees C., further preferably in a range from 5 degrees C. to 20 degrees C. Particularly by conducting the reaction at the reaction temperature of 20 degrees C. or less, coloration of the formed PC copolymer resin (1) can be restrained (i.e., increase in YI can be restrained).

A reaction pressure may be any one of a reduced pressure, a normal pressure and an added pressure. Typically, the reaction can be favorably performed under a pressure that is approximately equal to the normal pressure or a self-pressure of the reaction system. The reaction time, which is dependent on the reaction temperature, is typically in a range of 0.5 minute to 10 hours, preferably of 1 minute to about 2 hours.

At the time of the reaction, the dihydric phenol compound is desirably added in a form of at least one solution of an organic-solvent solution or an alkali aqueous solution. The order of the addition is not specifically limited. In the above manufacturing method, the catalyst, the terminal terminator, the branching agent and the like may be added as needed at the time of manufacturing polycarbonate oligomer or at the time of subsequent polymerization reaction, or both at the time of manufacturing polycarbonate oligomer and at the time of subsequent polymerization reaction.

For instance, when the polycarbonate copolymer resin represented by the formula (20) is manufactured as the PC resin (2), the monomer represented by the formula (10) in which Ar¹ is a group represented by a formula (10B) below and the monomer represented by the formula (11) in which Ar² is a group represented by a formula (11B) are used. The polycarbonate copolymer resin represented by the formula (20) is manufactured in the same manner as the above-described PC copolymer resin.

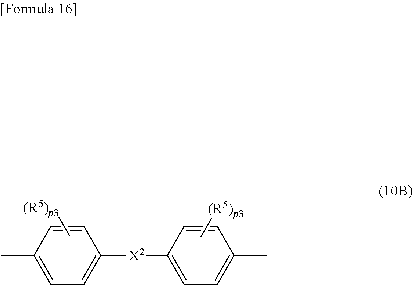

In the formula (10B), X² is —CR⁶R⁷—. R⁵ is an alkyl group having 1 to 3 carbon atoms. When a plurality of R⁵ are present, the plurality of R⁵ are mutually the same group or different groups. R⁶ and R⁷ are each independently selected from the group consisting of a hydrogen atom, an alkyl group having 1 to 12 carbon atoms, a trifluoromethyl group, and a substituted or unsubstituted aryl group having 6 to 12 ring carbon atoms. p³ is an integer of 0 to 2. A plurality of p³ are mutually the same or different.

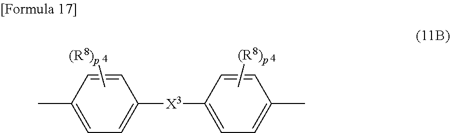

In the formula (11B), X³ is a single bond or —O—. R⁸ is an alkyl group having 1 to 3 carbon atoms. When a plurality of R⁸ are present, the plurality of R⁸ are mutually the same group or different groups. p⁴ is an integer of 0 to 2. A plurality of p⁴ are mutually the same or different.

Controlling the reduced viscosity [η_{SP}/C] (a value correlated to the viscosity-average molecular weight) of the obtained PC resin to fall within the above-described range is achievable by various methods, for instance, by selecting the reaction conditions of the PC resin and by adjusting an amount of a molecular weight adjuster to be used.

In addition, if necessary, the obtained resin composition may be subjected to a physical treatment such as mixing and cutoff and/or a chemical treatment such as polymer reaction, cross linking or partial degradation, so that the resin composition can also have a predetermined reduced viscosity [η_{SP}/C].

The obtained reaction product (crude product) may be subjected to various after-treatments such as known separation and refinement, so that the resin composition having a desirable purity (desirable refining degree) can be obtained.

### Electrophotographic Photoreceptor

An electrophotographic photoreceptor of the exemplary embodiment includes a photosensitive layer formed on a conductive substrate, the photosensitive layer containing the resin composition of the above exemplary embodiment as a component.

It is preferable that the photosensitive layer at least contains a charge generating agent, a charge transporting agent, and a binder resin, the binder resin containing the resin composition of the above exemplary embodiment.

While the resin composition of the above exemplary embodiment may be used in any part of the photosensitive layer, in order to sufficiently provide advantages of the invention, the resin composition is desirably used as the binder resin of the charge transporting agent in a charge transporting layer, as the binder resin of a single photosensitive layer, or as a surface protection layer. In a multi-layer electrophotographic photoreceptor having double charge transporting layers, the resin composition is preferably used in one of the double charge transporting layers.

In the electrophotographic photoreceptor of the exemplary embodiment, one of the polycarbonate resin having the repeating unit represented by the formula (2) may be used alone or a two or more of the polycarbonate resin may be used in combination in order to form the resin composition of the exemplary embodiment. Moreover, an additive such as an antioxidant may be contained as desired as long as an object of the invention is not hampered.

The electrophotographic photoreceptor of the exemplary embodiment includes the photosensitive layer formed on the conductive substrate.

When the photosensitive layer has the charge generating layer and the charge transporting layer, the charge transporting layer may be laminated on the charge generating layer, or the charge generating layer may be laminated on the charge transporting layer. Alternatively, the photosensitive layer may be a single-layer photosensitive layer simultaneously containing both the charge generating agent and the charge transporting agent. Moreover, a conductive or insulating protective film may be formed on a surface layer of the electrophotographic photoreceptor as needed. Further, the electrophotographic photoreceptor may be provided with an intermediate layer(s) such as adhesive layer for enhancing adhesion between layers and a blocking layer for blocking charges.

The electrophotographic photoreceptor of the exemplary embodiment may be in any form in addition to various known forms of the electrophotographic photoreceptor as long as the resin composition of the exemplary embodiment is contained in the photosensitive layer. In terms of a manufacturing cost, the electrophotographic photoreceptor is preferably a multi-layer electrophotographic photoreceptor, which includes a multi-layer photosensitive layer sequentially including at least one charge generating layer containing the charge generating agent and at least one charge transporting layer containing the charge transporting agent and the binder resin. Alternatively, the electrophotographic photoreceptor is also preferably a single-layer electrophotographic photoreceptor including a single-layer photosensitive layer at least containing the charge generating agent, the charge transporting agent, and the binder resin.

Various known materials are usable as a material for the conductive substrate used for the electrophotographic photoreceptor of the exemplary embodiment. Specific examples of the material for the conductive substrate include: a plate, a drum and a sheet made of material such as aluminum, nickel, chrome, palladium, titanium, molybdenum, indium, gold, platinum, silver, copper, zinc, brass, stainless steel, lead oxide, tin oxide, indium oxide, ITO (indium tin oxide; tin-doped indium oxide) and graphite; glass, cloth, paper, plastic film, plastic sheet and seamless belt having been treated with conductive treatment through coating by vapor deposition, sputtering or application; and a metal drum having been treated with metal oxidation treatment by electrode oxidation and the like.

The charge generating layer at least contains the charge generating agent. The charge generating layer can be obtained by forming a layer of the charge generating agent on the underlying substrate by vacuum deposition, sputtering or the like, or by forming a layer of the charge generating agent bound on the underlying substrate with use of the binder resin. Various known methods are usable as the method for forming the charge generating layer using the binder resin. In terms of the manufacturing cost, the charge generating layer is typically preferably formed as a molded article through a wet molding process of applying, for instance, a coating agent containing both the charge generating agent and the binder resin dispersed or dissolved in a suitable solvent onto a predetermined underlying substrate, and drying the applied coating agent.

Various known charge generating materials are usable as the charge generating agent in the charge generating layer. Examples of compounds for the materials include: elementary selenium such as amorphous selenium and trigonal selenium; selenium alloy such as selenium-tellurium; selenium compound or selenium-containing composition such as As₂Se₃; zinc oxide; inorganic material formed of 12 group element and 16 group element in the periodic system such as CdS—Se; oxide semiconductor such as titanium oxide; silicon material such as amorphous silicon; metal-free phthalocyanine pigment such as T-type metal-free phthalocyanine and X-type metal-free phthalocyanine; metal phthalocyanine pigment such as a-type copper phthalocyanine, P-type copper phthalocyanine, y-type copper phthalocyanine, E-type copper phthalocyanine, X-type copper phthalocyanine, A-type titanyl phthalocyanine, B-type titanyl phthalocyanine, C-type titanyl phthalocyanine, D-type titanyl phthalocyanine, E-type titanyl phthalocyanine, F-type titanyl phthalocyanine, G-type titanyl phthalocyanine, H-type titanyl phthalocyanine, K-type titanyl phthalocyanine, L-type titanyl phthalocyanine, M-type titanyl phthalocyanine, N-type titanyl phthalocyanine, Y-type titanyl phthalocyanine, oxotitanyl phthalocyanine, titanyl phthalocyanine whose black angle 26 has its diffraction peak at 27.3±0.2 degrees in an X-ray diffraction diagram, and gallium phthalocyanine; cyanine dye; anthracene pigment; bisazo pigment; pyrene pigment; polycyclic quinone pigment; quinacridone pigment; indigo pigment; perylene pigment; pyrylium dye; squarium pigment; anthoanthrone pigment; benzimidazole pigment; azo pigment; thioindigo pigment; quinoline pigment; lake pigment; oxazine pigment; dioxazine pigment; triphenylmethane pigment; azulenium dye; triarylmethane dye; xanthine dye; thiazine dye; thiapyrylium dye; polyvinyl carbazole; and bisbenzimidazole pigment. One of the above compounds may be used alone, or two or more thereof may be mixed for use as the charge generating agent. Among the above charge generating agent, a charge generating agent specifically disclosed in JP 11-172003 A is preferable in terms of performance and safety.

The charge transporting layer can be obtained as a molded article through a wet molding process of forming a layer of the charge transporting agent bound on the underlying conductive substrate with use of the binder resin.

In the exemplary embodiment, in terms of improvement in plate wear, at least one of the charge transporting layer of the multi-layer photoreceptor and the photosensitive layer of the single-layer photoreceptor preferably contains the binder resin containing the resin composition of the exemplary embodiment.

In the exemplary embodiment, any binder resin containing the resin composition of the exemplary embodiment is usable. Various known resins are usable in combination as the binder resin. Examples of the various known resins include polystyrene, polyvinyl chloride, polyvinyl acetate, vinyl chloride-vinyl acetate copolymer, polyvinyl acetal, alkyd resin, acrylic resin, polyacrylonitrile, polycarbonate, polyurethane, epoxy resin, phenol resin, polyamide, polyketone, polyacrylamide, butyral resin, polyester resin, vinylidene chloride-vinyl chloride copolymer, methacrylic resin, styrene-butadiene copolymer, vinylidene chloride-acrylonitrile copolymer, vinyl chloride-vinyl acetate-maleic anhydride copolymer, silicone resin, silicone-alkyd resin, phenol-formaldehyde resin, styrene-alkyd resin, melamine resin, polyether resin, benzoguanamine resin, epoxy-acrylate resin, urethane acrylate resin, poly-N-vinylcarbazole, polyvinyl butyral, polyvinyl formal, polysulphone, casein, gelatine, polyvinyl alcohol, ethyl cellulose, cellulose nitrate, carboxymethyl cellulose, vinylidene chloride-base polymer latex, acrylonitrile-butadiene copolymer, vinyl toluene-styrene copolymer, soybean oil-modified alkyd resin, nitrated polystyrene, polymethylstyrene, polyisoprene, polythiocarbonate, polyarylate, polyhaloarylate, polyallyl ether, polyvinyl acrylate and polyester acrylate. One of the above resins may be used alone, or two or more thereof may be mixed for use.

Various known methods are applicable for forming the charge transporting layer. However, in terms of the manufacturing cost, the charge transporting layer is preferably obtained as a molded article through a wet molding process of applying a coating liquid containing both the charge transporting agent and the binder resin dispersed or dissolved in a suitable solvent onto a predetermined underlying substrate, and drying the applied coating liquid. For forming the charge transporting layer, a blend ratio by mass of the charge transporting agent and the binder resin is preferably 20:80 to 80:20, more preferably 30:70 to 70:30.

In the charge transporting layer, one of the polycarbonate copolymer resin (main resin) represented by the formula (1) forming the resin composition contained in the binder resin may be used alone, or two or more thereof may be mixed for use. Moreover, one of the polycarbonate resin (blend resin) containing the repeating unit represented by the formula (2) and forming the resin composition contained in the binder resin may be used alone, or two or more thereof may be mixed for use.

The thickness of the thus formed charge transporting layer is preferably approximately in a range from 5 μm to 100 μm, more preferably from 10 μm to 30 μm. The charge transporting layer having the thickness of 5 μm or more can avoid a decrease in an initial potential. The charge transporting layer having the thickness of 100 μm or less can avoid a deterioration in the electrophotographic characteristics.

Various known compounds are usable as the charge transporting agent that is usable together with the binder resin containing the resin composition according to the exemplary embodiment. Preferable examples of such compounds are carbazole compound, indole compound, imidazole compound, oxazole compound, pyrazole compound, oxadiazole compound, pyrazoline compound, thiadiazole compound, aniline compound, hydrazone compound, aromatic amine compound, aliphatic amine compound, stilbene compound, fluorenone compound, butadiene compound, enamine compound, quinone compound, quinodimethane compound, thiazole compound, triazole compound, imidazolone compound, imidazolidine compound, bisimidazolidine compound, oxazolone compound, benzothiazole compound, benzimidazole compound, quinazoline compound, benzofuran compound, acridine compound, phenazine compound, poly-N-vinylcarbazole, polyvinyl pyrene, polyvinyl anthracene, polyvinyl acridine, poly-9-vinyl phenyl anthracene, pyrene-formaldehyde resin, ethylcarbazole resin, and a polymer having the above structure in the main chain or side chain. One of the above compounds may be used alone, or two or more of the above may be used in combination.

Among the above charge transporting agents, specifically exemplified compounds disclosed in JP 11-172003 A and charge transporting agents represented by the following structures are further preferably used in terms of the performance and safety.

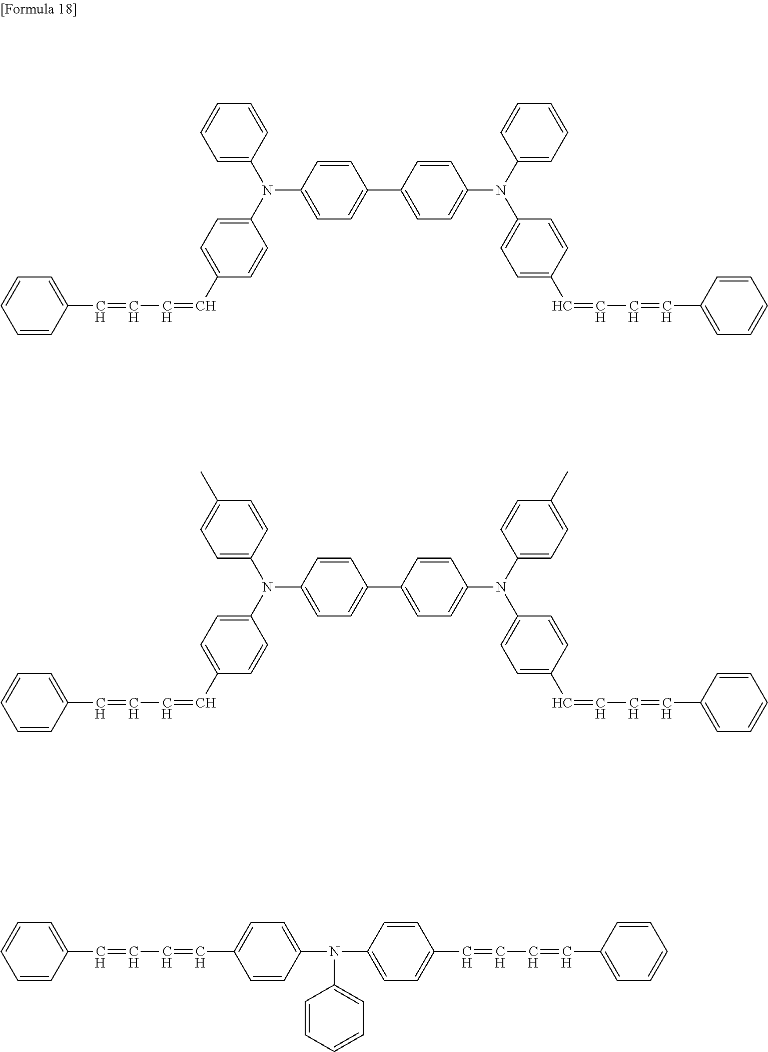 [SMILES: C(C=Cc1ccc(N(c2ccccc2)c2ccc(-c3ccc(N(c4ccccc4)c4ccc(C=CC=Cc5ccccc5)cc4)cc3)cc2)cc1)=Cc1ccccc1 ; Cc1ccc(N(c2ccc(C=CC=Cc3ccccc3)cc2)c2ccc(-c3ccc(N(c4ccc(C)cc4)c4ccc(C=CC=Cc5ccccc5)cc4)cc3)cc2)cc1 ; C(C=Cc1ccc(N(c2ccccc2)c2ccc(C=CC=Cc3ccccc3)cc2)cc1)=Cc1ccccc1]

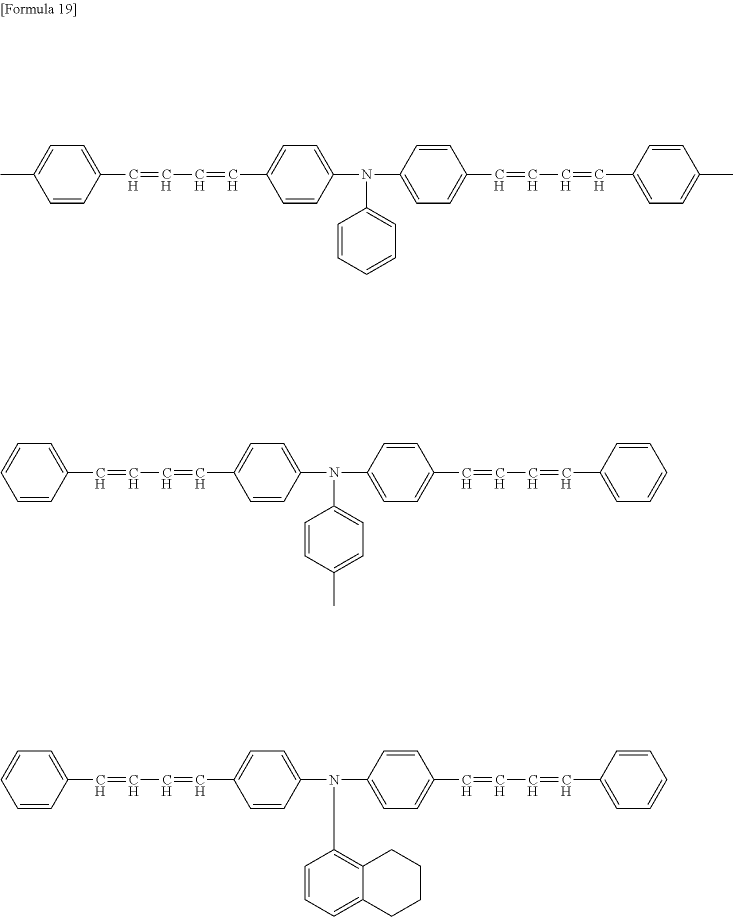

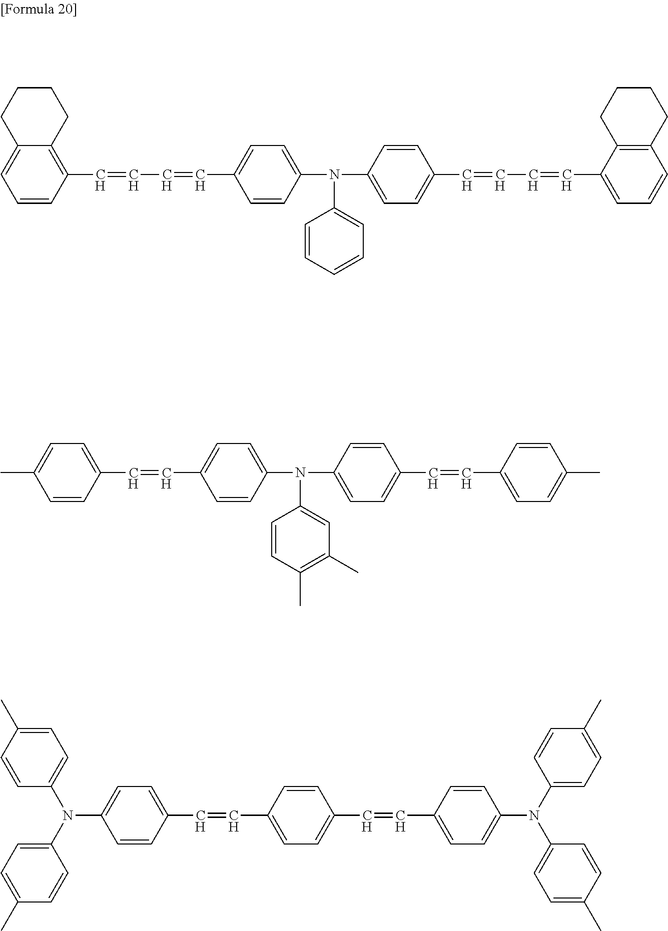

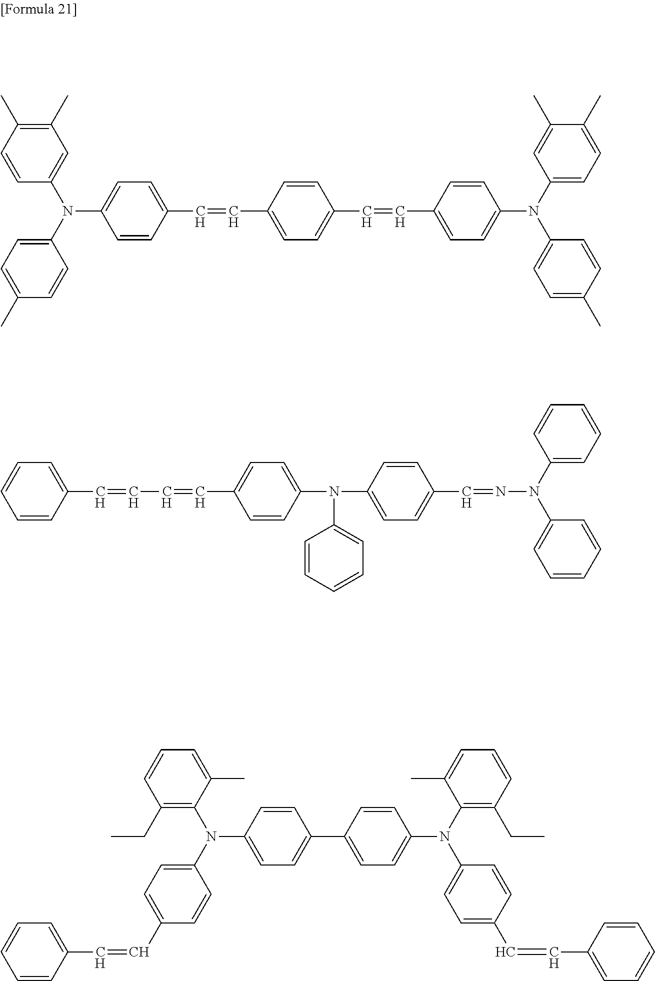 [SMILES: Cc1ccc(N(c2ccc(C=Cc3ccc(C=Cc4ccc(N(c5ccc(C)cc5)c5ccc(C)c(C)c5)cc4)cc3)cc2)c2ccc(C)c(C)c2)cc1 ; C(C=Cc1ccc(N(c2ccccc2)c2ccc(C=NN(c3ccccc3)c3ccccc3)cc2)cc1)=Cc1ccccc1 ; CCc1cccc(C)c1N(c1ccc(C=Cc2ccccc2)cc1)c1ccc(-c2ccc(N(c3ccc(C=Cc4ccccc4)cc3)c3c(C)cccc3CC)cc2)cc1]

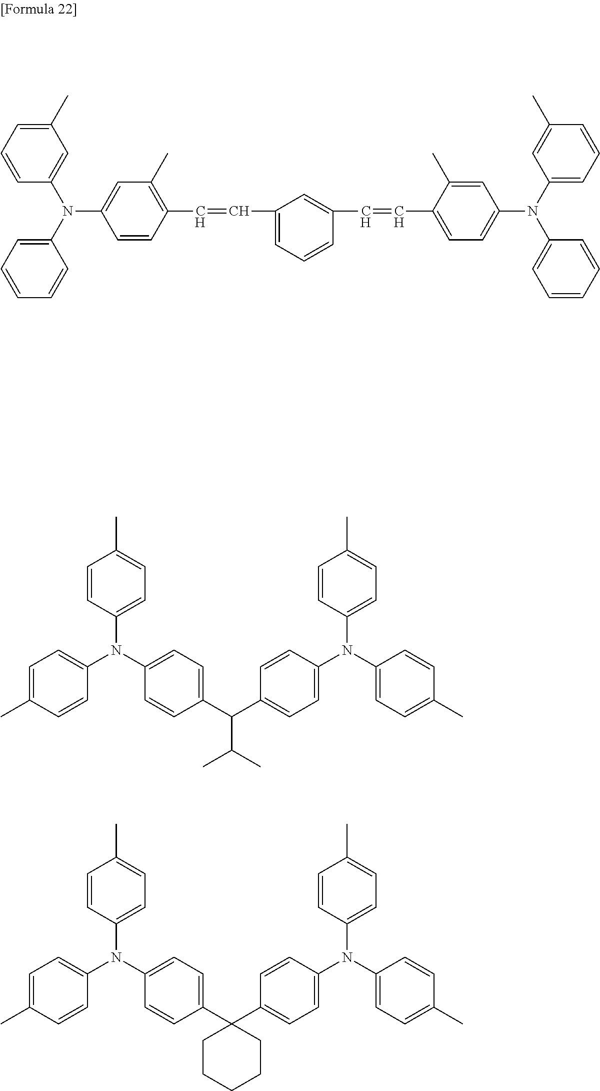

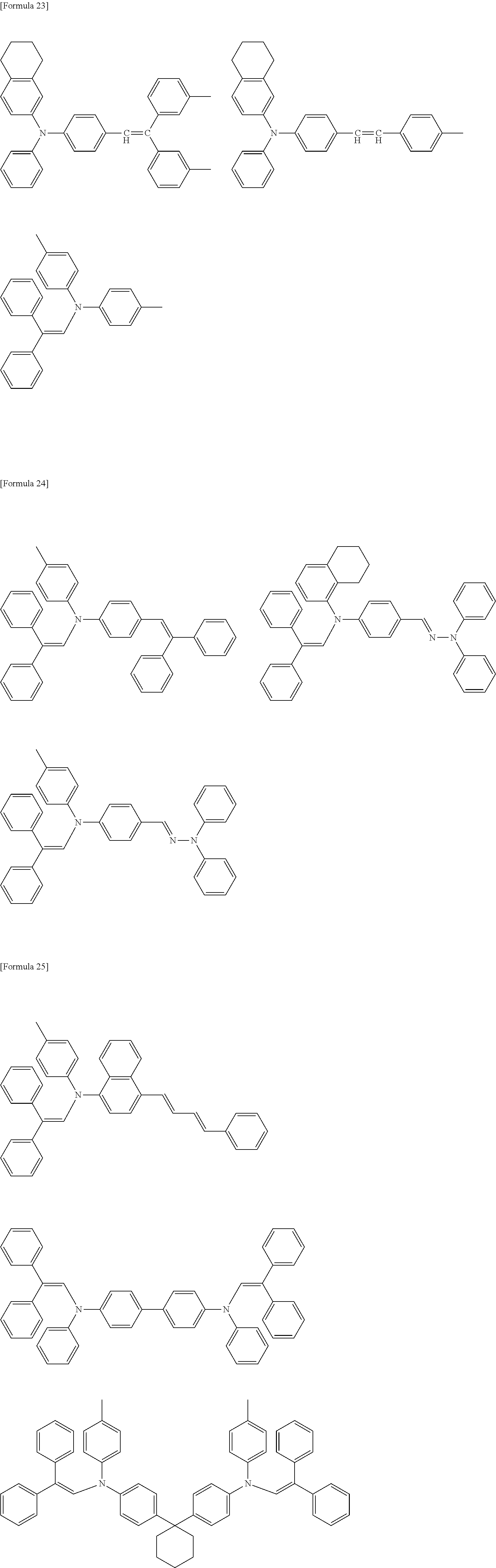

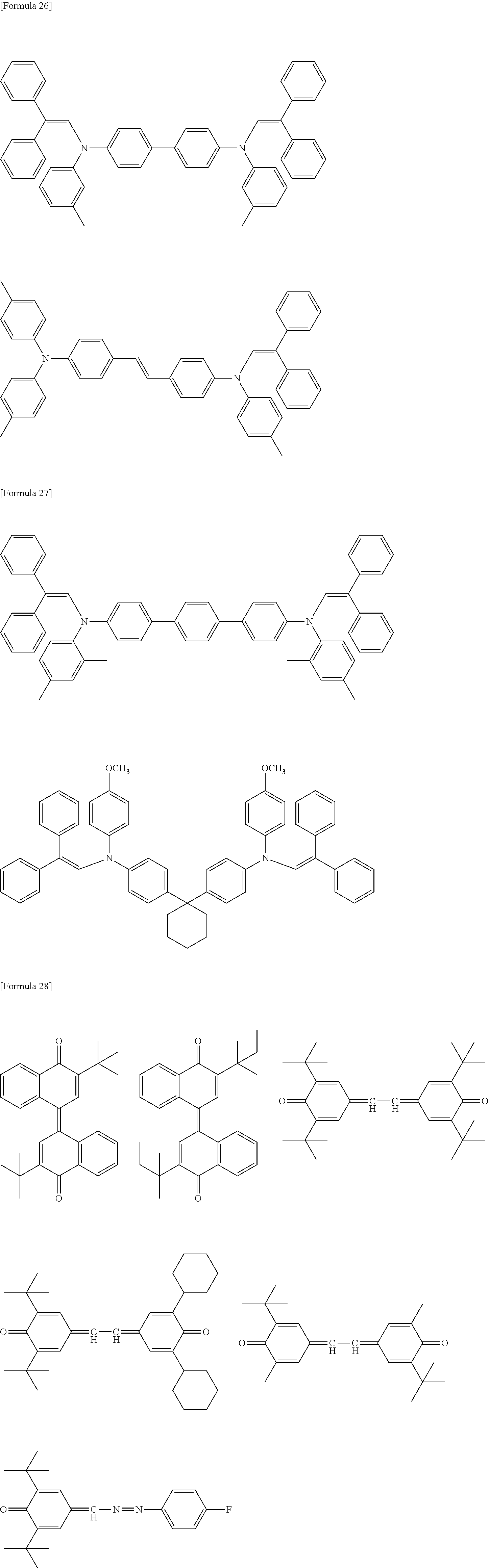

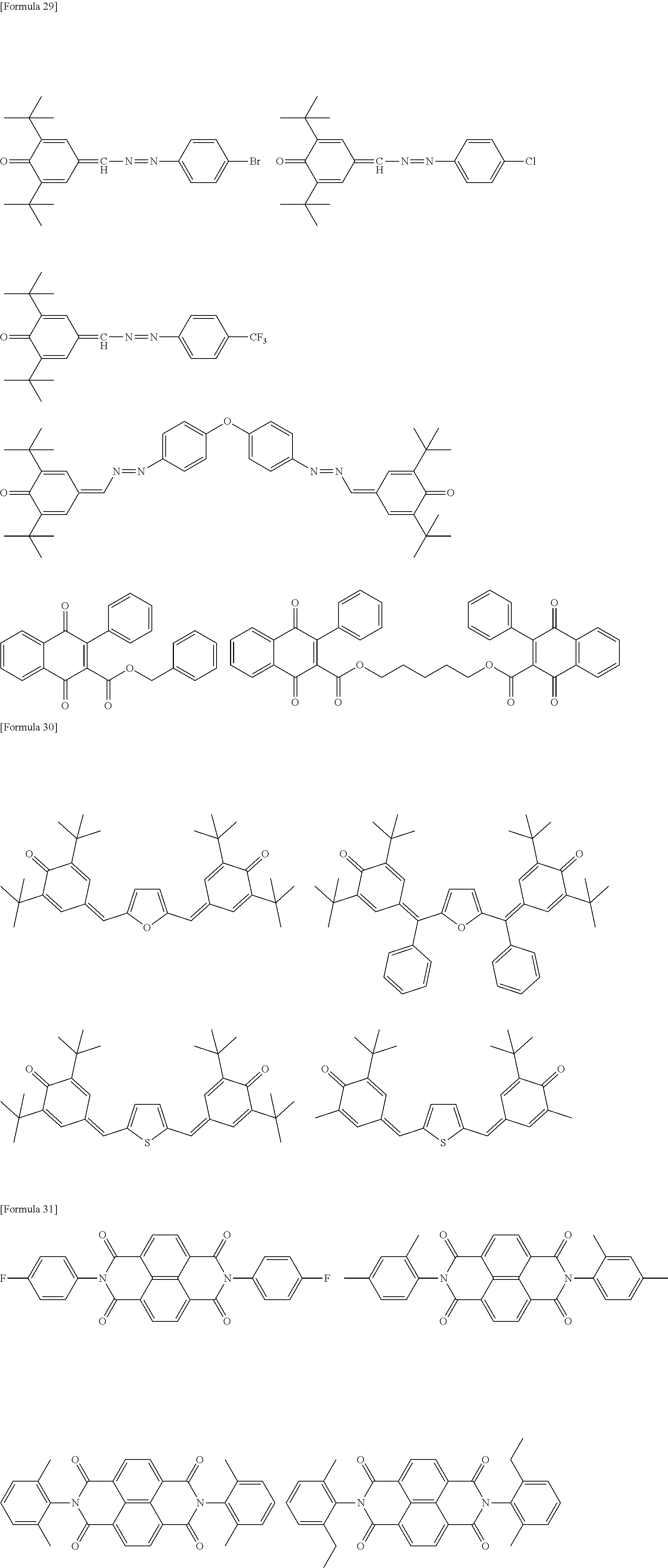

The electrophotographic photoreceptor of the exemplary embodiment may be provided with a typically-used undercoat layer between the conductive substrate and the photosensitive layer. Examples of the undercoat layer include particles such as titanium oxide, aluminum oxide, zirconia, titanic acid, zirconic acid, lanthanum lead, titanium black, silica, lead titanate, barium titanate, tin oxide, indium oxide and silicon oxide, and components such as polyamide resin, phenol resin, casein, melamine resin, benzoguanamine resin, polyurethane resin, epoxy resin, cellulose, cellulose nitrate, polyvinyl alcohol and polyvinyl butyral resin. As the resin usable for the undercoat layer, the resin composition of the exemplary embodiment is usable or known resins are usable. One of the above particles and the resins may be used alone or a variety thereof may be mixed for use. When the particles and the resins are used in a mixture, a combination of inorganic particles and a resin is preferable because a flat and smooth film can be made.

The thickness of the undercoat layer is preferably in a range from 0.01 μm to 10 μm, more preferably from 0.1 μm to 7 μm. The undercoat layer having the thickness of 0.01 μm or more can be formed evenly. The undercoat layer having the thickness of 10 μm or less can avoid a deterioration of the electrophotographic characteristics.

The electrophotographic photoreceptor of the exemplary embodiment may be provided with a typically-used known blocking layer between the conductive substrate and the photosensitive layer. As the blocking layer, the resin composition of the exemplary embodiment is usable or known resins are usable. The thickness of the blocking layer is preferably in a range from 0.01 μm to 20 μm, more preferably from 0.1 μm to 10 μm. The blocking layer having the thickness of 0.01 μm or more can be formed evenly. The blocking layer having the thickness of 20 μm or less can avoid a deterioration of the electrophotographic characteristics.

The electrophotographic photoreceptor of the exemplary embodiment may be further provided with a protection layer laminated on the photosensitive layer. As the protection layer, the resin composition of the exemplary embodiment is usable or known resins are usable. The thickness of the protection layer is preferably in a range from 0.01 μm to 20 μm, more preferably from 0.1 μm to 10 μm in terms of a product performance.

The protection layer may contain a conductive material such as the charge generating agent, the charge transporting agent, an additive, a metal, oxides of the metal, nitrides thereof, salts thereof, alloy thereof, carbon black and an organic conductive compound.

In order to enhance performance of the electrophotographic photoreceptor, the charge generating layer and the charge transporting layer may be added with a binding agent, a plasticizer, a curing catalyst, a fluidity adder, a pinhole controller, a spectral-sensitivity sensitizer (sensitizer dye) and the like. In addition, in order to prevent increase in residual potential, reduction in charged potential and deterioration of sensitivity in repetitive use, various chemical substances and additives such as antioxidant, surfactant, curl inhibitor and leveling agent may be added to the charge generating layer and the charge transporting layer.

Examples of the binding agent include silicone resin, polyamide resin, polyurethane resin, polyester resin, epoxy resin, polyketone resin, polycarbonate copolymer, polystyrene resin, polymethacrylate resin, polyacrylamide resin, polybutadiene resin, polyisoprene resin, melamine resin, benzoguanamine resin, polychloroprene resin, polyacrylonitrile resin, ethyl cellulose resin, cellulose nitrate resin, urea resin, phenol resin, phenoxy resin, polyvinyl butyral resin, formal resin, vinyl acetate resin, vinyl acetate/vinyl chloride copolymer resin, and polyester carbonate resin. In addition, at least one of a thermoset resin or a light-curable resin is also usable. The binding agent is not specifically limited to the above, as long as the binding agent is an electric-insulating resin from which a film is formable under normal conditions, and as long as an advantage of the invention is not hampered. The binding agent is preferably contained at 80 mass % or less relative to the charge transporting agent in terms of the product performance.

Examples of the plasticizer include biphenyl, chlorinated biphenyl, o-terphenyl, halogenated paraffin, dimethylnaphthalene, dimethyl phthalate, dibutyl phthalate, dioctyl phthalate, diethylene glycol phthalate, triphenyl phosphate, diisobutyl adipate, dimethyl sebacate, dibutyl sebacate, laurate butyl, methylphthalyl ethyl glycolate, dimethyl glycol phthalate, methylnaphthalene, benzophenone, polypropylene, polystyrene, and fluorohydrocarbon.

Examples of the curing catalyst are methanesulfonic acid, dodecylbenzenesulfonic acid and dinonylnaphthalene disulfonic acid. Examples of the fluidity adder are Modaflow™ and Acronal 4FT^{M}. Examples of the pinhole controller are benzoin and dimethyl phthalate.

The above plasticizer, curing catalyst, fluidity adder and pinhole controller are preferably contained at 5 mass % or less relative to the charge transporting agent in terms of the manufacturing cost.

When a sensitizer dye is used as the spectral-sensitivity sensitizer, in terms of the manufacturing cost and safety, suitable examples of the sensitizer dye are triphenylmethane-base dye such as methyl violet, crystal violet, night blue and Victria blue, acridine dye such as erythrosine, Rhodamine B, Rhodamine 3R, acridine orange and frapeosine, thiazine dye such as methylene blue and methylene green, oxazine dye such as capri blue and meldra blue, cyanine dye, merocyanine dye, styryl dye, pyrylium salt dye and thiopyrylium salt dye.

In order to enhance the sensitivity, reduce the residual potential and reduce fatigue due to repeated use, the photosensitive layer may be added with an electron-accepting substance. Preferable examples of the electron-accepting substance include compounds having high electron affinity such as succinic anhydride, maleic anhydride, dibromo maleic anhydride, phthalic anhydride, tetrachloro phthalic anhydride, tetrabromo phthalic anhydride, 3-nitro phthalic anhydride, 4-nitro phthalic anhydride, pyromellitic anhydride, mellitic anhydride, tetracyanoethylene, tetracyanoquinodimethane, o-dinitro benzene, m-dinitro benzene, 1,3,5-trinitro benzene, p-nitrobenzonitrile, picryl chloride, quinone chlorimide, chloranil, bromanil, benzoquinone, 2,3-dichloro benzoquinone, dichloro dicyano parabenzoquinone, naphthoquinone, diphenoquinone, tropoquinone, anthraquinone, 1-chloro anthraquinone, dinitro anthraquinone, 4-nitrobenzophenone, 4.4-dinitrobenzophenone, 4-nitrobenzal malonodinitrile, α-cyano-β-(p-cyanophenyl) ethyl acrylate, 9-anthracenyl methylmalonodinitrile, 1-cyano-(p-nitrophenyl)-2-(p-chlorophenyl) ethylene, 2,7-dinitro fluorenone, 2,4,7-trinitro fluorenone, 2,4,5,7-tetranitro fluorenone, 9-fluorenylidene-(dicyano methylene malononitrile), polynitro-9-fluorenylidene-(dicyano methylene malonodinitrile), picric acid, o-nitrobenzoic acid, p-nitrobenzoic acid, 3,5-dinitrobenzoic acid, pentafluorobenzoic acid, 5-nitrosalicylic acid, 3,5-dinitrosalicylic acid, phthalic acid and mellitic acid. The above compounds may be added to either the charge generating layer or the charge transporting layer. In terms of the product performance, a blend ratio of the compounds is preferably 0.01 part by mass to 200 parts by mass per 100 parts by mass of the charge generating agent or the charge transporting agent, more preferably 0.1 part by mass to 50 parts by mass.

Further, in order to improve surface quality, tetrafluoroethylene resin, trifluoroethylene chloride resin, tetrafluoroethylene hexafluoropropylene resin, vinyl fluoride resin, vinylidene fluoride resin, difluoroethylene dichloride resin, copolymer(s) thereof, or fluorine-base graft polymer may be used as a surface modifier. A blend ratio of the surface modifier is preferably in a range from 0.1 mass % to 60 mass % relative to the binder resin, more preferably in a range of 5 mass % to 40 mass %. The blend ratio of 0.1 mass % or more of the surface modifier provides a sufficient surface modification such as enhancement of surface durability and reduction in surface energy. The blend ratio of 60 mass % or less of the surface modifier avoids a deterioration of the electrophotographic characteristics.

Preferable examples of the antioxidant include a hindered phenol antioxidant, aromatic amine antioxidant, hindered amine antioxidant, sulfide antioxidant and organophosphate antioxidant. A blend ratio of the antioxidant is preferably in a range from 0.01 mass % to 10 mass % relative to the charge transporting agent, more preferably in a range of 0.1 mass % to 2 mass % in terms of the product performance.

Preferable examples of the antioxidant are compounds represented by chemical formulae disclosed in the Specification of JP 11-172003 A ([Formula 94] to [Formula 101]) in terms of the manufacturing cost and safety.

One of the above antioxidants may be used alone, or two or more thereof may be mixed for use. The antioxidant may be added to at least one of the surface protection layer, the undercoat layer or the blocking layer, in addition to the photosensitive layer.

Examples of the solvent usable in forming the charge generating layer and the charge transporting layer are aromatic solvents such as benzene, toluene, xylene and chlorobenzene, ketones such as acetone, methyl ethyl ketone and cyclohexaneone, alcohols such as methanol, ethanol and isopropanol, esters such as acetic ether and ethyl cellosolve, halogenated hydrocarbons such as carbon tetrachloride, carbon tetrabromide, chloroform, dichloromethane and tetrachloroethane, ethers such as tetrahydrofuran, dioxolane and dioxane, and amides such as dimethylformamide, dimethylsulfoxide, and diethyl formamide. One of the above solvents may be used alone, or two or more thereof may be used together as a mixture solvent.

The photosensitive layer of a single-layer electrophotographic photoreceptor can be easily formed by applying the resin composition according to the exemplary embodiment as the binder resin with use of the charge generating agent, the charge transporting agent and the additive. Moreover, in terms of the product performance, the charge transporting agent is preferably added with at least one of the above-described hole transporting agent or electron transporting agent. Electron transporting agents exemplified in JP 2005-139339 A are preferably usable as the electron transporting agent in terms of the manufacturing cost and safety.

Various coating applicators (e.g., known applicators) can perform application of each layer. Examples of such a coating applicator are an applicator, a spray coater, a bar coater, a chip coater, a roll coater, a dip coater and a doctor blade.

The thickness of the photosensitive layer in the electrophotographic photoreceptor is preferably in a range from 5 μm to 100 μm, more preferably from 8 μm to 50 μm. The photosensitive layer having the thickness of 5 μm or more can avoid a decrease in an initial potential. The photosensitive layer having the thickness of 100 μm or less can avoid a deterioration in the electrophotographic characteristics. A mass ratio of the charge generating agent to the binder resin used for manufacturing the electrophotographic photoreceptor is preferably 1:99 to 30:70, more preferably 3:97 to 15:85 in terms of the product performance and the manufacturing cost. Moreover, a mass ratio of the charge transporting agent to the binder resin is preferably 10:90 to 80:20, more preferably 30:70 to 70:30 in terms of the product performance and the manufacturing cost.

Since the electrophotographic photoreceptor is typically manufactured by dissolving a functional material and a binder resin in an organic solvent and film-casting the obtained solvent on a conductive substrate and the like, solubility of the binder resin in the organic solvent and stability of the obtained solution are required. Since the electrophotographic photoreceptor of this exemplary embodiment contains the resin composition of the exemplary embodiment, a coating agent is neither whitened nor gelled in manufacturing the photosensitive layer.

Moreover, since the electrophotographic photoreceptor of the exemplary embodiment contains the resin composition of the exemplary embodiment in the photosensitive layer, the electrophotographic photoreceptor exhibits an excellent durability (abrasion resistance) and excellent electrical characteristics (electrification characteristics) to keep excellent electrophotographic characteristics for a long time. Accordingly, the electrophotographic photoreceptor of the exemplary embodiment is favorably applicable to various electrophotographic fields such as copier (black and white copier, multi-color copier, full-color copier; analog copier, digital copier), printer (laser printer, LED printer, liquid-crystal shutter printer), facsimile, platemaker and equipment capable of functioning as a plurality of them.

Further, since the resin composition of the exemplary embodiment is obtained by adding the resin having a high solubility and favorable electrical characteristics (i.e., the polycarbonate resin having the repeating unit represented by the formula (2)) to the resin having an excellent wear resistance (i.e., the polycarbonate copolymer resin represented by the formula (1)), the electrophotographic photoreceptor of the exemplary embodiment containing the resin composition of the exemplary embodiment exhibits a favorable wear resistance and satisfactory electrical characteristics.

### Electrophotographic Device

The electrophotographic photoreceptor of the exemplary embodiment is favorably applicable to an electrophotographic device.

The electrophotographic photoreceptor of the exemplary embodiment is electrified in use by corona discharge (corotron, scorotron), contact charging (charge roll, charge brush) or the like. Examples of the charge roll include a charge roll by DC electrification and a charge roll by AC and DC superimposed electrification. For exposure, a halogen lamp, a fluorescent lamp, laser (semiconductor, He—Ne), LED or a photoreceptor internal exposure system may be used. For image development, dry developing such as cascade developing, two-component magnetic brush developing, one-component insulating toner developing and one-component conductive toner developing, and wet developing may be used. For transfer, electrostatic transfer such as corona transfer, roller transfer and belt transfer, pressure transfer and adhesive transfer may be used. For fixing, heat roller fixing, radiant flash fixing, open fixing, pressure fixing and the like may be used. For cleaning and neutralizing, brush cleaner, magnetic brush cleaner, electrostatic brush cleaner, magnetic roller cleaner, blade cleaner and the like may be used. It should be noted that washing and neutralizing may be performed without a cleaner. Examples of a resin for toner are styrene-base resin, styrene-acrylic base copolymer resin, polyester, epoxy resin and cyclic hydrocarbon polymer. The toner may be spherical or amorphous. The toner may also be controlled to have a certain shape (such as spheroidal shape and potato shape). The toner may be pulverized toner, suspension-polymerized toner, emulsion-polymerized toner, chemically-pelletized toner, or ester-elongation toner.

### Second Exemplary Embodiment

An arrangement of a resin composition in a second exemplary embodiment will be described. In the description of the second exemplary embodiment, the same components as those of the first exemplary embodiment will be denoted by the same name and the explanation thereof will omitted or simplified. In the second exemplary embodiment, the same compounds and the like and examples thereof as those described in the first exemplary embodiment are usable unless specifically described.

A resin composition according to the second exemplary embodiment contains the polycarbonate copolymer resin represented by the formula (1) and a polyarylate resin having a repeating unit represented by a formula (3). Provided that a total of the polycarbonate copolymer resin represented by the formula (1) and the polyarylate resin having the repeating unit represented by the formula (3) is defined as 100 parts by mass, the content of the polycarbonate copolymer resin represented by the formula (1) is in a range from 50 parts by mass to 95 parts by mass.

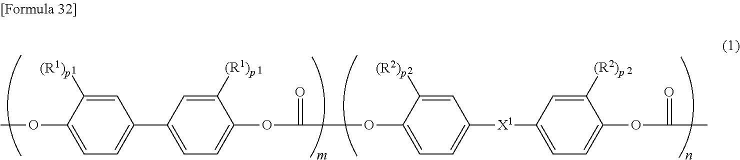

In the formula (1), m and n each represent an average repeating number of a skeleton unit. A molar copolymer composition represented by m/(m+n) ranges from 0.4 to 0.67.

In the formula (1), X¹ is selected from the group consisting of —O—, —CR³R⁴—, and a substituted or unsubstituted cycloalkylidene group having 5 to 12 carbon atoms.

When a plurality of X¹ are present, the plurality of X¹ are mutually the same group or different groups.

R¹ and R² are each independently an alkyl group having 1 to 3 carbon atoms or perfluoroalkyl group having 1 to 3 carbon atoms.

A plurality of R¹ are mutually the same group or different groups.

When a plurality of R² are present, the plurality of R² are mutually the same group or different groups.

R³ and R⁴ are each independently selected from the group consisting of a hydrogen atom, an alkyl group having 1 to 12 carbon atoms, and a trifluoromethyl group.

When a plurality of R³ are present, the plurality of R³ are mutually the same group or different groups.

When a plurality of R⁴ are present, the plurality of R⁴ are mutually the same group or different groups.

p¹ is 1 or 2. A plurality of p¹ are mutually the same or different.

p² is an integer of 0 to 2. A plurality of p² are mutually the same or different.

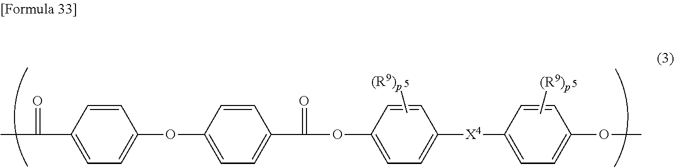

In the formula (3), X¹ is selected from the group consisting of a single bond, —CR¹⁰R¹¹—, and a substituted or unsubstituted cycloalkylidene group having 5 to 12 carbon atoms.

R⁹ is an alkyl group having 1 to 3 carbon atoms. When a plurality of R⁹ are present, the plurality of R⁹ are mutually the same group or different groups.

R¹⁰ and R¹¹ are each independently selected from the group consisting of a hydrogen atom, an alkyl group having 1 to 12 carbon atoms, a trifluoromethyl group, and a substituted or unsubstituted aryl group having 6 to 12 ring carbon atoms.

p⁵ is an integer of 0 to 2. A plurality of p⁵ are mutually the same or different.

In the second exemplary embodiment, provided that the total of the polycarbonate copolymer resin represented by the formula (1) and the polyarylate resin having the repeating unit represented by the formula (3) is defined as 100 parts by mass, the content of the polycarbonate copolymer resin represented by the formula (1) is preferably in a range from 70 parts by mass to 95 parts by mass.

In the resin composition of the exemplary embodiment, the polyarylate resin having the repeating unit represented by the formula (3) is preferably a polyarylate resin consisting of the repeating unit represented by the formula (3) except for chain ends.

When the resin composition of the exemplary embodiment is applied to the electrophotographic photoreceptor of the exemplary embodiment, the resin composition of the exemplary embodiment may contain a single one of the polyarylate resin having the repeating unit represented by the formula (3) or a combination of two or more of the polyarylate resin.

The resin composition of the exemplary embodiment can be exemplarily manufactured according to the later-described Examples.

### Manufacturing Method of Polyarylate Resin

Any methods are usable as a manufacturing method of the polyarylate resin having the repeating unit represented by the formula (3) forming the resin composition of the exemplary embodiment. For instance, known polymerization methods such as an interfacial polymerization method, a melt polymerization method, and a solution polymerization method are usable. Among the polymerization methods, the interfacial polymerization method is suitable in terms of a polymerization temperature, reaction control, and handleability (e.g., washing and collection) of the polymers.

In manufacturing the polyarylate resin according to the interfacial polymerization method, for instance, a solution in which dihydric phenol is dissolved in an alkali solution is mixed with a halogenated hydrocarbon solution in which a divalent carboxylic acid chloride component is dissolved. At this time, a nitrogen compound (e.g., benzyl triethyl ammonium chloride) or a phosphorus compound (e.g., tetrabutyl phosphonium bromide) is usually added as a polymerization catalyst in terms of productivity.

Typically, it is preferable that a polymerization temperature is in a range from 0 degrees C. to 40 degrees C. and a polymerization time is in a range from 2 hours to 20 hours. After the polymerization, the aqueous phase and the organic phase are separated. Polymers dissolved in the organic phase are washed and collected by known methods, so that a target polyarylate resin is obtained.

Examples of the alkali component used for preparing the alkali aqueous solution of dihydric phenol include alkali metal hydroxides such as sodium hydroxide and potassium hydroxide. An amount of the alkali component to be used is preferably in a range from 1.01 to 3 times equivalent to the phenol hydroxyl group contained in a reaction system.

Examples of halogenated hydrocarbon used for preparing the halogenated hydrocarbon solution of divalent carboxylic acid chloride include dichloromethane, chloroform, 1,2-dichloroethane, trichloroethane, tetrachloroethane, and dichlorbenzene.

Examples of the polymerization catalyst include a nitrogen compound and a phosphorus compound. Examples of the nitrogen compound include salts of tertiary amine with hydrochloric acid, bromic acid, iodic acid and the like. Specific examples of the nitrogen compound include benzyltriethyl ammonium chloride, benzyltrimethyl ammonium chloride, benzyltributyl ammonium chloride, tetraethyl ammonium chloride, tetrabutyl ammonium chloride, tetrabutyl ammonium bromide, and trioctylmethyl ammonium chloride.

Examples of the phosphorus compound include salts of tertiary phosphorus compound with hydrochloric acid, bromic acid, iodic acid and the like. Specific examples of the phosphorus compound include tetrabutyl phosphonium bromide, triethyl octadecyl phosphonium bromide, tetrabutyl phosphonium chloride, N-lauryl pyridinium chloride, lauryl picolinium chloride, and benzyltriphenyl phosphonium chloride. A plurality of the compounds are usable in combination.

A terminal terminator is added as needed at a polymerization reaction. Examples of the terminal terminator include phenol, alkylphenols (e.g., o,m,p-cresol, o,m,p-ethylphenol, o,m,p-propylphenol, o,m,p-(tert-butyl)phenol, pentylphenol, hexylphenol, octylphenol, nonylphenol, a 2,6-dimethylphenol derivative and a 2-methylphenol derivative), monofunctional phenol (e.g., o,m,p-phenylphenol), and monofunctional acid halide (e.g., acetyl chloride, butyryl chloride, octylic acid chloride, benzoyl chloride, benzene sulfonyl chloride, benzene sulfinyl chloride, sulfinyl chloride, benzene phosphonyl chloride, and derivatives thereof).

Among the above terminal terminators, due to a high molecular weight adjustability and a solution stability, o,m,p-(tert-butyl)phenol, a 2,6-dimethylphenol derivative, and a 2-methylphenol derivative are preferable and p-(tert-butyl)phenol, 2,5-dimethylphenol, 2,3,6-trimethylphenol, and 2,3,5-trimethylphenol are particularly preferable. A plurality of ones of the above terminal terminators are usable in combination.

The polyarylate resin represented by the formula (3) is manufactured by a polymerization reaction of diphenyl ether dicarboxylic acid chloride and dihydric phenol.

Specific examples of diphenyl ether dicarboxylic acid chloride include acid chlorides of diphenyl ether-2,2′-dicarboxylic acid, diphenyl ether-2,3′-dicarboxylic acid, diphenyl ether-2,4′-dicarboxylic acid, diphenyl ether-3,3′-dicarboxylic acid, diphenyl ether-3,4′-dicarboxylic acid, and diphenyl ether-4,4′-dicarboxylic acid.

Among the above examples, in consideration of an easy manufacturing of diphenyl ether dicarboxylic acid chloride, diphenyl ether dicarboxylic acid chloride is preferably at least one of acid chloride of diphenyl ether-2,2′-dicarboxylic acid, acid chloride of diphenyl ether-2,4′-dicarboxylic acid, or acid chloride of diphenyl ether-4,4′-dicarboxylic acid.

Specific examples of dihydric phenol include a biphenyl compound and a bisphenol compound.

Examples of the biphenyl compound include 4,4′-biphenol, 3,3′-dimethyl-4,4′-dihydroxybiphenyl, 3,3′-diethyl-4,4′-dihydroxybiphenyl, and 3,3′,5,5′-tetramethyl-4,4′-dihydroxybiphenyl.

Examples of the bisphenol compound include a bisphenol compound having no substituent in an aromatic ring, a bisphenol compound having one substituent in an aromatic ring, a bisphenol compound having a (4-hydroxy-3-ethylphenyl) group, a bisphenol compound having two substituents in an aromatic ring, and a bisphenol compound having three substituents in an aromatic ring.

Examples of the bisphenol compound having no substituent in an aromatic ring include bis(4-hydroxyphenyl)methane, 1,1-bis(4-hydroxyphenyl)ethane, 1,1-bis(4-hydroxyphenyl)propane, 2,2-bis(4-hydroxyphenyl)propane, 1,1-bis(4-hydroxyphenyl)butane, 2,2-bis(4-hydroxyphenyl)butane, 1,1-bis(4-hydroxyphenyl)pentane, 2,2-bis(4-hydroxyphenyl)pentane, 3,3-bis(4-hydroxyphenyl)pentane, 1,1-bis(4-hydroxyphenyl)hexane, 2,2-bis(4-hydroxyphenyl)hexane, 3,3-bis(4-hydroxyphenyl)hexane, and 1,1-bis(4-hydroxyphenyl)cyclohexane.

Examples of the bisphenol compound having one substituent in an aromatic ring include bis(4-hydroxy-3-methylphenyl)methane, 1,1-bis(4-hydroxy-3-methylphenyl)ethane, 1,1-bis(4-hydroxy-3-methylphenyl)propane, 2,2-bis(4-hydroxy-3-methylphenyl)propane, and 1,1-bis(4-hydroxy-3-methylphenyl)cyclohexane.

Examples of the bisphenol compound having a (4-hydroxy-3-ethylphenyl) group include bis(4-hydroxy-3-ethylphenyl)methane, 1,1-bis(4-hydroxy-3-ethylphenyl)ethane, 1,1-bis(4-hydroxy-3-ethylphenyl)propane, 2,2-bis(4-hydroxy-3-ethylphenyl)propane, and 1,1-bis(4-hydroxy-3-ethylphenyl)cyclohexane.

Examples of the bisphenol compound having two substituents in an aromatic ring include bis(4-hydroxy-3,5-dimethylphenyl)methane, 1,1-bis(4-hydroxy-3,5-dimethylphenyl)ethane, 2,2-bis(4-hydroxy-3,5-dimethylphenyl)propane, 1,1-bis(4-hydroxy-3,5-dimethylphenyl)cyclohexane, bis(4-hydroxy-3,6-dimethylphenyl)methane, 1,1-bis(4-hydroxy-3,6-dimethylphenyl)ethane, and 2,2-bis(4-hydroxy-3,6-dimethylphenyl)propane.

Examples of the bisphenol compound having three substituents in an aromatic ring include bis(4-hydroxy-2,3,5-trimethylphenyl)methane, 1,1-bis(4-hydroxy-2,3,5-trimethylphenyl)ethane, 2,2-bis(4-hydroxy-2,3,5-trimethylphenyl)propane, and 1,1-bis(4-hydroxy-2,3,5-trimethylphenyl)cyclohexane.

Among the above examples, the bisphenol compound having one substituent in an aromatic ring is preferable in terms of wear resistance and solubility.

Since the resin composition of the exemplary embodiment is obtained by adding the resin having a high solubility and favorable wear resistance (i.e., the polyarylate resin including the repeating unit represented by the formula (3)) to the resin having an excellent wear resistance (i.e., the polycarbonate copolymer resin represented by the formula (1)), the electrophotographic photoreceptor of the the exemplary embodiment containing the resin composition of the exemplary embodiment exhibits a favorable wear resistance and satisfactory electrical characteristics.

The electrophotographic photoreceptor of the second exemplary embodiment includes a conductive substrate and a photosensitive layer formed on the conductive substrate, the photosensitive layer containing the resin composition of the second exemplary embodiment as a component. It is preferable that the electrophotographic photoreceptor of the second exemplary embodiment includes the conductive substrate and the photosensitive layer formed on the conductive substrate, in which the photosensitive layer at least contains a charge generating agent, a charge transporting agent, and a binder resin, the binder resin containing the resin composition of the second exemplary embodiment.

The electrophotographic photoreceptor of the second exemplary embodiment can be configured to be the same as the electrophotographic photoreceptor of the first exemplary embodiment except for the above.

Since the electrophotographic photoreceptor of the second exemplary embodiment contains the resin composition of the exemplary embodiment, a coating agent is neither whitened nor gelled in manufacturing the photosensitive layer.

Moreover, since the electrophotographic photoreceptor of the second exemplary embodiment contains the resin composition of the exemplary embodiment in the photosensitive layer, the electrophotographic photoreceptor exhibits an excellent durability (abrasion resistance) and excellent electrical characteristics (electrification characteristics) to keep excellent electrophotographic characteristics for a long time. Accordingly, the electrophotographic photoreceptor of the second exemplary embodiment is favorably applicable to various electrophotographic fields such as copier (black and white copier, multi-color copier, full-color copier; analog copier, digital copier), printer (laser printer, LED printer, liquid-crystal shutter printer), facsimile, platemaker and equipment capable of functioning as a plurality of them.

The electrophotographic device of the second exemplary embodiment can be configured to be the same as the electrophotographic device of the first exemplary embodiment except for having the electrophotographic photoreceptor of the exemplary embodiment (the second exemplary embodiment).

### EXAMPLES

### Examples

Next, the invention will be described in detail with reference to Examples and Comparatives. However, the invention is not limited to the examples but may include various modifications and applications as long as such modifications and applications do not depart from a technical idea of the invention.

### Manufacturing Example: Preparation of Oligomer

### Manufacturing Example 1: Synthesis of OC—BP Oligomer (Bischloroformate)

150.0 g (0.701 mol) of 3,3′-dimethyl-4,4′-dihydroxybiphenyl (OC-BP) was suspended in 1100 mL of methylene chloride, to which 186 g (1.88 mol) of phosgene was added and dissolved. Into this obtained solution, a solution in which 199.4 g (1.97 mol) of triethylamine was dissolved in 460 mL of methylene chloride was dropped at 13 degrees C. to 16 degrees C. for 2 hours and 50 minutes to obtain a reaction mixture. The reaction mixture was stirred at 14 degrees C. to 16 degrees C. for 30 minutes. The stirred reaction mixture was added with 5.0 mL of concentrated hydrochloric acid and 200 mL of deionized water to be washed. Subsequently, washing with water was repeated until an aqueous layer becomes neutral. Thus, a methylene chloride solution of an OC—BP oligomer having a chloroformate group at its molecular end was obtained.

The obtained solution had a chloroformate concentration of 0.51 mol/L, a solid concentration of 0.09 kg/L and an average number of repeating units (n1) of 1.01. This material obtained in Manufacturing Example 1 is referred to as “OCBP-CF” hereinafter.

The average number of repeating units (n1) was obtained by a numerical formula below.

The average number of repeating units (n1)=1+(Mav−M1)/M2 (Numerical Formula 1)

In the numerical formula 1, May represents (2×1000/(CF value), M2 represents (M1-98.92), and M1 represents a molecular weight of a bischloroformate oligomer assuming that the bischloroformate oligomer is monomer. The CF value (N/kg) represents (CF value/concentration). The CF value (N) represents the number of chlorine atoms in the bischloroformate compound oligomer contained in 1 L of the reaction solution. The solid concentration (kg/L) represents an amount of a solid content obtained by concentrating the 1-L reaction solution. Herein, 98.92 is a total atom weight of two chlorine atoms, one oxygen atom and one carbon atom which are desorbed at polycondensation of the bischloroformate oligomers.

### Manufacturing Example 2: Synthesis of DE-BP Oligomer (Bischloroformate)

150.0 g (0.620 mol) of 3,3′-diethyl-4,4′-dihydroxybiphenyl (DE-BP) was suspended in 1100 mL of methylene chloride, to which 186 g (1.88 mol) of phosgene was added and dissolved. Into this obtained solution, a solution in which 199.4 g (1.97 mol) of triethylamine was dissolved in 460 mL of methylene chloride was dropped at 13 degrees C. to 16 degrees C. for 2 hours and 50 minutes to obtain a reaction mixture. The reaction mixture was stirred at 14 degrees C. to 16 degrees C. for 30 minutes. The stirred reaction mixture was added with 5.0 mL of concentrated hydrochloric acid and 200 mL of deionized water to be washed. Subsequently, washing with water was repeated until an aqueous layer becomes neutral. Thus, a methylene chloride solution of a DE-BP oligomer having a chloroformate group at its molecular end was obtained.

The obtained solution had a chloroformate concentration of 0.54 mol/L, a solid concentration of 0.10 kg/L and an average number of repeating units (n1) of 1.01. This material obtained in Manufacturing Example 2 is referred to as “DEBP-CF”hereinafter.

### Manufacturing Example 3: Synthesis of DHPE Oligomer (Bischloroformate)

45.2 kg (224 mol) of 4,4-dihydroxydiphenyl ether (DHPE) was suspended in 1080 L of methylene chloride, to which 66.0 kg (667 mol) of phosgene was added and dissolved. To this solution, a solution in which 44.0 kg (435 mol) of triethylamine was dissolved in 120 L of methylene chloride was dropped at 2.2 degrees C. to 17.8 degrees C. for 2 hours and 50 minutes to obtain a reaction mixture. After the obtained reaction mixture was stirred at 17.9 degrees C. to 19.6 degrees C. for 30 minutes, 900 L of methylene chloride was distilled away at 14 degrees C. to 20 degrees C. The residual solution was added with 210 L of deionized water, 1.2 kg of concentrated hydrochloric acid and 450 g of hydrosulphite to be washed. Subsequently, washing with 210 L of deionized water was repeated five times. A methylene chloride solution of DHPE oligomer having a chloroformate group at its molecular end was obtained.

The obtained solution had a chloroformate concentration of 1.14 mol/L, a solid concentration of 0.19 kg/L and an average number of repeating units (n1) of 1.03. This material obtained in Manufacturing Example 3 is referred to as “DHPE-CF” hereinafter.

### Manufacturing Example 4: Synthesis of BisZ Oligomer (Bischloroformate)

60.0 kg (224 mol) of 1,1-bis(4-hydroxyphenyl)cyclohexane (bisphenol Z) was suspended in 1080 L of methylene chloride, to which 66.0 kg (667 mol) of phosgene was added and dissolved. To this solution, a solution in which 44.0 kg (435 mol) of triethylamine was dissolved in 120 L of methylene chloride was dropped at 2.2 degrees C. to 17.8 degrees C. for 2 hours and 50 minutes to obtain a reaction mixture. After the obtained reaction mixture was stirred at 17.9 degrees C. to 19.6 degrees C. for 30 minutes, 900 L of methylene chloride was distilled away at 14 degrees C. to 20 degrees C. The residual solution was added with 210 L of deionized water, 1.2 kg of concentrated hydrochloric acid and 450 g of hydrosulphite to be washed. Subsequently, washing with 210 L of deionized water was repeated five times. A methylene chloride solution of a bisphenol Z oligomer having a chloroformate group at its molecular end was obtained.

The obtained solution had a chloroformate concentration of 1.14 mol/L, a solid concentration of 0.22 kg/L and an average number of repeating units (n1) of 1.02. This material obtained in Manufacturing Example 4 is referred to as “Z-CF” hereinafter.

### Manufacturing Example 5: Synthesis of Bisphenol E Oligomer (Bischloroformate)

Into a mixed solution containing 73.0 g (0.341 mol) of 1,1-bis(4-hydroxyphenyl)ethane (bisphenol E), 410 mL of methylene chloride and 68 g (0.689 mol) of phosgene, a solution prepared by diluting 68.7 g (0.682 mol) of triethylamine with 245 mL of methylene chloride was dropped at 14 degrees C. to 18.5 degrees C. for 2 hours and 50 minutes to obtain a reaction mixture. After stirring the reaction mixture at 18.5 degrees C. to 19 degrees C. for one hour, 250 mL of methylene chloride was distilled away at 10 degrees C. to 22 degrees C. Subsequently, the reaction mixture was added with 5.0 mL of concentrated hydrochloric acid, 73 mL of deionized water, and 0.47 g of hydrosulphite to be washed. Subsequently, washing with water was repeated until an aqueous layer becomes neutral. Thus, a methylene chloride solution of the bisphenol E oligomer having a chloroformate group at its molecular end was obtained.

The obtained solution had a chloroformate concentration of 1.31 mol/L, a solid concentration of 0.23 kg/L and an average number of repeating units (n1) of 1.10. This material obtained in Manufacturing Example 5 is referred to as “E-CF” hereinafter.

### Manufacturing Example 6: Synthesis of Co-Oligomer of Bisphenol CZ and OC—BP

80 kg (0.270 kmol) of 1,1-bis(3-methyl-4-hydroxyphenyl)cyclohexane (bisphenol CZ), 38 kg (0.177 kmol) of 3,3′-dimethyl-4,4′-dihydroxybiphenyl (OC—BP), and 851 L of methylene chloride were mixed into a solution in which 46 kg of sodium hydroxide and 64 kg of potassium hydroxide were dissolved in 1649 L of water to obtain a mixture solution. Under cooling, phosgene was blown at a rate of 150 kg/h into the mixture solution for 30 minutes while the mixture solution was stirred. Next, the reaction solution was separated in a stand still manner, and a methylene chloride solution of a polycarbonate oligomer having a chloroformate group at its molecular terminal was obtained.

The obtained solution had a chloroformate concentration of 0.61 mol/L, a solid concentration of 0.165 kg/L and an average number of repeating units (n1) of 1.67. This material obtained in Manufacturing Example 6 is referred to as “PCOCZOC” hereinafter.

### Manufacturing Example 7: Synthesis of Bisphenol E Oligomer

81 g of 1,1-bis(4-hydroxyphenyl)ethane and 350 mL of methylene chloride were mixed into 550 mL of aqueous sodium hydroxide of 2N concentration to obtain a mixture solution. Under cooling, phosgene was blown at a rate of 950 mL/minute for 30 minutes into the mixture solution while the mixture solution was stirred. Next, the reaction solution was separated in a stand still manner, and a methylene chloride solution of a polycarbonate oligomer having a chloroformate group at its molecular terminal was obtained.

The obtained solution had a chloroformate concentration of 0.93 mol/L, a solid concentration of 0.27 kg/L and an average number of repeating units (n1) of 3.60. This material obtained in Manufacturing Example 7 is referred to as “PCOBE” hereinafter.

### Example 1

### Synthesis of Main Resin

OCBP-CF (172.6 mL) of Manufacturing Example 1 and methylene chloride (95 mL) were put into a reactor provided with a mechanical stirrer, stirring vane and baffle plate. This solution was added with 2,2-difluoro-2-(1,1,2,2-tetrafluoro-2-(1,1,2,3,3,3-hexafluoro-2-(trifluoromethyl)propoxy)ethoxy)ethanol (0.357 g) (i.e., a terminal terminator) and stirred to be fully mixed. After a temperature inside the reactor was cooled down to 15 degrees C., an entire amount of the prepared dihydric phenol solution was added to the obtained mixture solution, to which 2.0 mL of a triethylamine aqueous solution (7 vol %) was added with stirring and the stirring was continued for one hour.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC1-1) having the following structure.

The dihydric phenol solution in Example 1 was separately prepared by: preparing 91 mL of 1.4N potassium hydroxide aqueous solution (8.27 g of potassium hydroxide); after cooling the solution to the room temperature or lower, adding 0.2 g of hydrosulphite as an antioxidant, 9.06 g of 1,1-bis(4-hydroxyphenyl)cyclohexane, and 2.16 g of 3,3′-diethyl-4,4′-dihydroxybiphenyl to the solution; and completely dissolving the added compounds in the solution.

The PC resin (PC1-1) was identified as a PC copolymer having 1.35 dL/g of a reduced viscosity [nsp/C] and the following structure.

It should be noted that, after the obtained resin was dissolved in methylene chloride to prepare a solution of 0.5 g/dL concentration, the reduced viscosity [rsp/C] at 20 degrees C. of the PC resin was measured using RIGO AUTO VISCOMETER TYPE VMR-052USPC (manufactured by RIGO CO., LTD.) and an Ubbelohde viscosity tube.

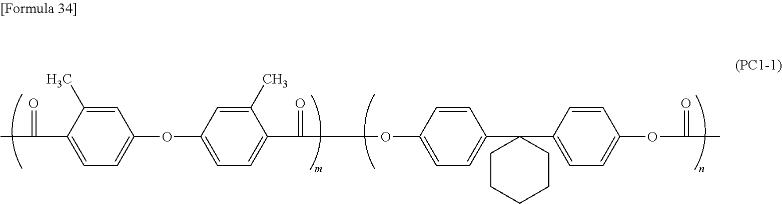

m/(m+n)=0.6

n/(m+n)=0.4

The above structure of the PC resin was identified according to the following procedure. Firstly, the structure of the PC resin was analyzed for identification by the ¹H-NMR spectroscopy and ¹³C-NMR spectroscopy. Molar copolymerization ratios m/(m+n) and n/(m+n) of the respective skeleton units were calculated from the integrated intensity.

### Synthesis of Blend Resin

PCOBE (183.8 mL) of Manufacturing Example 7 and methylene chloride (207 mL) were put into a reactor provided with a mechanical stirrer, stirring vane and baffle plate. To this solution, p-tert-butylphenol (PTBP) (0.576 g) was added as a terminal terminator and stirred for sufficient mixing. A dihydric phenol solution was prepared by a method including: preparing 127 mL of 2.4N aqueous sodium hydroxide (12.6 g of sodium hydroxide); after cooling the solution at the room temperature or less, adding 0.1 g of hydrosulphite as an antioxidant, 9.2 g of 4,4′-biphenol, and 1.8 g of 1,1-bis(4-hydroxyphenyl)ethane to the solution; and completely dissolving the mixed solution. After an inner temperature of the reactor was cooled down to 15 degrees C., all amount of the dihydric phenol solution separately prepared as described above was added to the above solution. 2.0 mL of a triethylamine aqueous solution (7 vol %) was added with stirring and the stirring was continued for one hour.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC2-1) having the following structure.

The PC resin (PC2-1) was identified as a PC copolymer having 1.18 dL/g of a reduced viscosity [η_{SP}/C] and a structure with the following repeating units and composition by the ¹H-NMR spectroscopy and ¹³C-NMR spectroscopy.

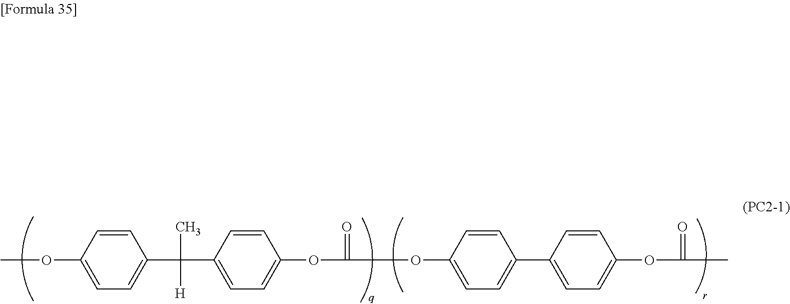

q/(q+r)=0.85

r/(q+r)=0.15

The main resin (PC1-1) and blend resin (PC2-1) described above were mixed at a mass ratio of PC1-1:PC2−1=90 parts by mass:10 parts by mass to obtain a resin composition (1A).

An electrophotographic photoreceptor was manufactured using the resin composition (1A). The electrophotographic photoreceptor was manufactured as described below.

### Manufacturing of Electrophotographic Photoreceptor

An aluminum film (film thickness: 50 μm) was used as a conductive substrate. A charge generating layer and a charge transporting layer were sequentially laminated on the surface of the conductive substrate to form a multi-layer photosensitive layer, thereby providing an electrophotographic photoreceptor. 0.5 g of oxotitanium phthalocyanine was used as a charge generating agent while 0.5 g of a butyral resin was used as a binder resin. The charge generating agent and the binder resin were added into 19 g of methylene chloride (solvent) and dispersed with a ball mill. Then, the dispersion was applied with a bar coater onto the surface of the aluminum film (the conductive substrate) and dried, thereby forming a charge generating layer having a film thickness of approximately 0.5 μm. Moreover, for use as a charge transporting agent, 0.5 g of a compound represented by the following formula (CTM-1) and 0.5 g of the resin composition (1A) were dispersed in 10 mL of tetrahydrofuran to prepare a coating liquid. This coating liquid was applied with an applicator onto the charge generating layer and dried, thereby providing a charge transporting layer having a film thickness of approximately 20 μm.

The obtained electrophotographic photoreceptor was attached to an aluminum drum having a 60-mm diameter. A favorable electrical continuity was observed between the aluminum drum and the electrophotographic photoreceptor.

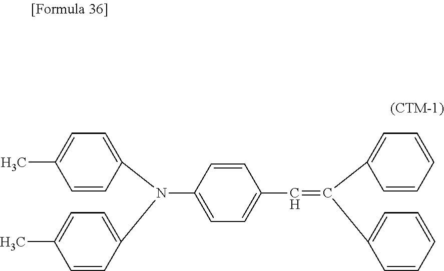 [SMILES: Cc1ccc(N(c2ccc(C)cc2)c2ccc(C=C(c3ccccc3)c3ccccc3)cc2)cc1]

### Example 2

### Synthesis of Main Resin

PC1-1 was synthesized by the same method as in Example 1.

### Synthesis of Blend Resin

DHPE-CF (373.5 mL) of Manufacturing Example 3 and methylene chloride (83 mL) were put into a reactor provided with a mechanical stirrer, stirring vane and baffle plate. To this solution, PTBP (0.189 g) was added as a terminal terminator and stirred for sufficient mixing. A 2,2-bis(4-hydroxyphenyl)butane (bisphenol B) solution was prepared by a method including: preparing 140 mL of 1.5N aqueous potassium hydroxide (13.3 g of potassium hydroxide); after cooling the solution at the room temperature or less, adding 0.1 g of hydrosulphite as an antioxidant and 16.02 g of 2,2-bis(4-hydroxyphenyl)butane (bisphenol B) to the solution; and completely dissolving the mixed solution. After an inner temperature of the reactor was cooled down to 15 degrees C. after the above stirring, all amount of the 2,2-bis(4-hydroxyphenyl)butane (bisphenol B) solution separately prepared as described above was added to the above solution. 2.0 mL of a triethylamine aqueous solution (7 vol %) was added with stirring and the stirring was continued for one hour, so that a reaction mixture was obtained.

The obtained reaction mixture was diluted with 0.2 L of methylene chloride and 0.1 L of water to be washed. A lower layer of the reaction mixture was separated. The reaction mixture was further washed with 0.1 L of water one time, with 0.1 L of 0.03N hydrochloric acid one time, and with 0.1 L of water three times in this order. The obtained methylene chloride solution was dropped into methanol with stirring. The obtained redeposit was filtered and dried to obtain a PC resin (PC2-2).

The PC resin (PC2-2) was identified as a PC copolymer having 1.40 dL/g of a reduced viscosity [η_{SP}/C] and a structure with the following repeating units and composition by the ¹H-NMR spectroscopy and ¹³C-NMR spectroscopy.

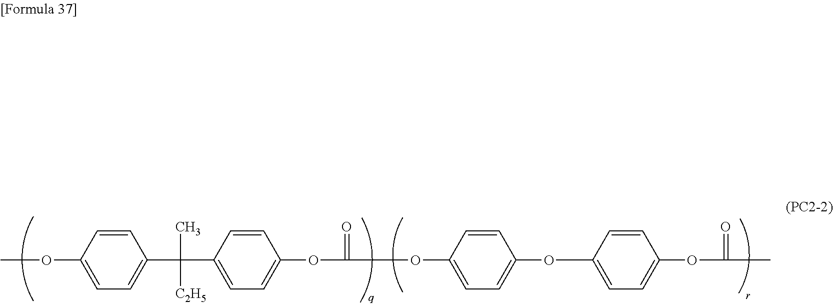

q/(q+r)=0.3

r/(q+r)=0.7

The main resin (PC1-1) and blend resin (PC2-2) described above were mixed at a mass ratio of PC1-1:PC2−2=90 parts by mass:10 parts by mass to obtain a resin composition (1B).

An electrophotographic photoreceptor was manufactured in the same manner as in Example 1 except that the resin composition (1B) was used in place of the resin composition (1 A).

### Example 3

### Synthesis of Main Resin

OCBP-CF (172.6 mL) of Manufacturing Example 1 and methylene chloride (95 mL) were put into a reactor provided with a mechanical stirrer, stirring vane and baffle plate. This solution was added with 2,2-difluoro-2-(1,1,2,2-tetrafluoro-2-(1,1,2,3,3,3-hexafluoro-2-(trifluoromethyl)propoxy)ethoxy)ethanol (0.357 g) (i.e., a terminal terminator) and stirred to be fully mixed. A 1,1-bis(3-methyl-4-hydroxyphenyl)cyclohexane (bisphenol CZ) solution was prepared by a method including: preparing 91 mL of 1.4N aqueous potassium hydroxide (8.27 g of potassium hydroxide); after cooling the solution at the room temperature or less, adding 0.2 g of hydrosulphite as an antioxidant, 9.61 g of 1,1-bis(3-methyl-4-hydroxyphenyl)cyclohexane, and 2.16 g of 3,3′-diethyl-4,4′-dihydroxybiphenyl to the solution; and completely dissolving the mixed solution. After an inner temperature of the reactor was cooled down to 15 degrees C. after the above stirring, all amount of the 1,1-bis(3-methyl-4-hydroxyphenyl)cyclohexane (bisphenol CZ) solution separately prepared as described above was added to the above solution. 2.0 mL of a triethylamine aqueous solution (7 vol %) was added with stirring and the stirring was continued for one hour, so that a reaction mixture was obtained.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC1-2) having the following structure.

The PC resin (PC1-2) was identified as a PC copolymer having 1.33 dL/g of a reduced viscosity [η_{SP}/C] and a structure with the following repeating units and composition by the ¹H-NMR spectroscopy and ¹³C-NMR spectroscopy.

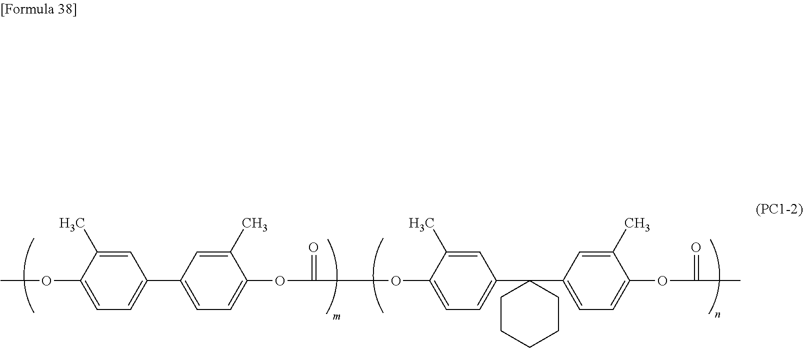

m/(m+n)=0.52

n/(m+n)=0.48

### Synthesis of Blend Resin

PC2-1 was synthesized by the same method as in Example 1.

The main resin (PC1-2) and blend resin (PC2-1) described above were mixed at a mass ratio of PC1-2:PC2−1=90 parts by mass:10 parts by mass to obtain a resin composition (1C).

An electrophotographic photoreceptor was manufactured in the same manner as in Example 1 except that the resin composition (1C) was used in place of the resin composition (1 A).

### Example 4

### Synthesis of Main Resin

PC1-2 was synthesized by the same method as in Example 3.

### Synthesis of Blend Resin

PC2-2 was synthesized by the same method as in Example 2.

The main resin (PC1-2) and blend resin (PC2-2) described above were mixed at a mass ratio of PC1-2:PC2−2=90 parts by mass:10 parts by mass to obtain a resin composition (1 D).

An electrophotographic photoreceptor was manufactured in the same manner as in Example 1 except that the resin composition (1 D) was used in place of the resin composition (1 A).

### Example 5

### Synthesis of Main Resin

PCOCZOC (91.3 mL) of Manufacturing Example 6 and methylene chloride (76 mL) were put into a reactor provided with a mechanical stirrer, stirring vane and baffle plate. To this solution, p-tert-butylphenol (PTBP) (0.109 g) was added as a terminal terminator and stirred for sufficient mixing. A 3,3′-dimethyl-4,4′-dihydroxybiphenyl (OC—BP) solution was prepared by a method including: preparing 56 mL of 1.8N aqueous sodium hydroxide (4.11 g of sodium hydroxide); after cooling the solution at the room temperature or less, adding 0.3 g of hydrosulphite as an antioxidant and 4.75 g of 3,3′-dimethyl-4,4′-dihydroxybiphenyl to the solution; and completely dissolving the mixed solution. After an inner temperature of the reactor was cooled down to 15 degrees C., all amount of the 3,3′-dimethyl-4,4′-dihydroxybiphenyl (OC—BP) solution separately prepared as described above was added to the above solution. 1.0 mL of a triethylamine aqueous solution (7 vol %) was added with stirring and the stirring was continued for one hour, so that a reaction mixture was obtained.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC1-3) having the following structure.

The PC resin (PC1-3) was identified as a PC copolymer having 1.25 dL/g of a reduced viscosity [η_{SP}/C] and a structure with the following repeating units and composition by the ¹H-NMR spectroscopy and ¹³C-NMR spectroscopy.

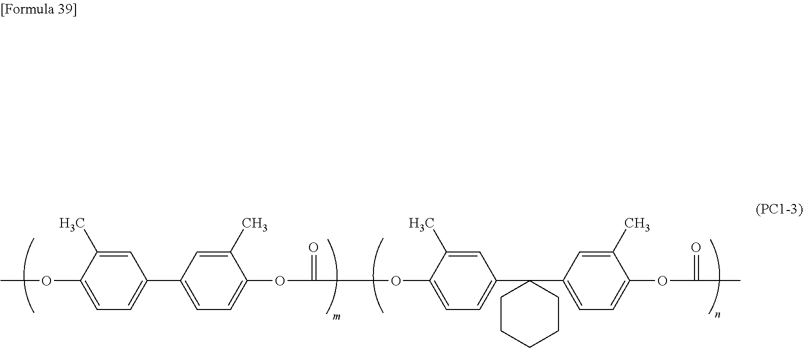

m/(m+n)=0.55

n/(m+n)=0.45

### Synthesis of Blend Resin

PC2-1 was synthesized by the same method as in Example 1.

The main resin (PC1-3) and blend resin (PC2-1) described above were mixed at a mass ratio of PC1-3:PC2-1=90 parts by mass:10 parts by mass to obtain a resin composition (1E).

An electrophotographic photoreceptor was manufactured in the same manner as in Example 1 except that the resin composition (1E) was used in place of the resin composition (1 A).

### Example 6

### Synthesis of Main Resin

OCBP-CF (172.6 mL) of Manufacturing Example 1 and methylene chloride (95 mL) were put into a reactor provided with a mechanical stirrer, stirring vane and baffle plate. This solution was added with 2,2-difluoro-2-(1,1,2,2-tetrafluoro-2-(1,1,2,3,3,3-hexafluoro-2-(trifluoromethyl)propoxy)ethoxy)ethanol (0.357 g) (i.e., a terminal terminator) and stirred to be fully mixed. A 1,1-bis(4-hydroxyphenyl)cyclohexane (bisphenol Z) solution was prepared by a method including: preparing 91 mL of 1.4N aqueous potassium hydroxide (8.27 g of potassium hydroxide); after cooling the solution at the room temperature or less, adding 0.2 g of hydrosulphite as an antioxidant and 11.78 g of 1,1-bis(3-methyl-4-hydroxyphenyl)cyclohexane to the solution; and completely dissolving the mixed solution. After an inner temperature of the reactor was cooled down to 15 degrees C. after the above stirring, all amount of the 1,1-bis(4-hydroxyphenyl)cyclohexane (bisphenol Z) solution separately prepared as described above was added to the above solution. 2.0 mL of a triethylamine aqueous solution (7 vol %) was added with stirring and the stirring was continued for one hour, so that a reaction mixture was obtained.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC1-4) having the following structure.

The PC resin (PC1-4) was identified as a PC copolymer having 1.32 dL/g of a reduced viscosity [η_{SP}/C] and a structure with the following repeating units and composition by the ¹H-NMR spectroscopy and ¹³C-NMR spectroscopy.

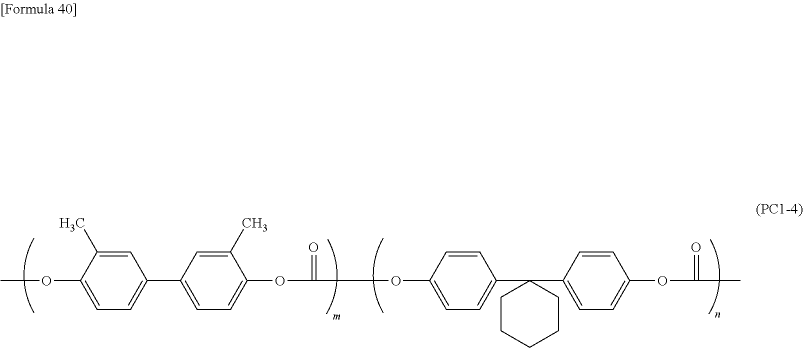

m/(m+n)=0.51

n/(m+n)=0.49

### Synthesis of Blend Resin

PC2-1 was synthesized by the same method as in Example 1.

The main resin (PC1-4) and blend resin (PC2-1) described above were mixed at a mass ratio of PC1-4:PC2−1=90 parts by mass:10 parts by mass to obtain a resin composition (1F).

An electrophotographic photoreceptor was manufactured in the same manner as in Example 1 except that the resin composition (1F) was used in place of the resin composition (1 A).

### Example 7

### Synthesis of Main Resin

OCBP-CF (172.6 mL) of Manufacturing Example 1 and methylene chloride (95 mL) were put into a reactor provided with a mechanical stirrer, stirring vane and baffle plate. To this solution, p-tert-butylphenol (PTBP) (0.124 g) was added as a terminal terminator and stirred for sufficient mixing. A 2,2′-bis(4-hydroxyphenyl)propane (bisphenol A) solution was prepared by a method including: preparing 91 mL of 1.4N aqueous potassium hydroxide (8.27 g of potassium hydroxide); after cooling the solution at the room temperature or less, adding 0.2 g of hydrosulphite as an antioxidant and 10.02 g of 2,2′-bis(4-hydroxyphenyl)propane to the solution; and completely dissolving the mixed solution. After an inner temperature of the reactor was cooled down to 15 degrees C. after the above stirring, all amount of the 2,2′-bis(4-hydroxyphenyl)propane (bisphenol A) solution separately prepared as described above was added to the above solution. 2.0 mL of a triethylamine aqueous solution (7 vol %) was added with stirring and the stirring was continued for one hour, so that a reaction mixture was obtained.

The obtained reaction mixture was diluted with 0.80 L of methylene chloride and 0.22 L of water to be washed. A lower layer of the reaction mixture was separated. The reaction mixture was further washed with 0.26 L of water one time, with 0.1 L of 0.03N hydrochloric acid one time, and with 0.26 L of water three times in this order. The obtained methylene chloride solution was dropped into methanol with stirring. The obtained redeposit was filtered and dried to obtain a PC resin (PC1-5) having the following structure.

The PC resin (PC1-5) was identified as a PC copolymer having 1.34 dL/g of a reduced viscosity [η_{SP}/C] and a structure with the following repeating units and composition by the ¹H-NMR spectroscopy and ¹³C-NMR spectroscopy.

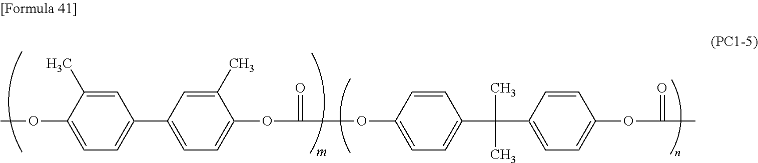

m/(m+n)=0.52

n/(m+n)=0.48

### Synthesis of Blend Resin

PC2-1 was synthesized by the same method as in Example 1.

The main resin (PC1-5) and blend resin (PC2-1) described above were mixed at a mass ratio of PC1-5:PC2−1=90 parts by mass:10 parts by mass to obtain a resin composition (1G).

An electrophotographic photoreceptor was manufactured in the same manner as in Example 1 except that the resin composition (1G) was used in place of the resin composition (1 A).

### Example 8

### Synthesis of Main Resin

PC1-4 was synthesized by the same method as in Example 6.

### Synthesis of Blend Resin

6.66 g of 4,4′-dibenzoyl oxychloride and 236 mL of methylene chloride were put into a reactor provided with a mechanical stirrer, stirring vane and baffle plate. To this solution, PTBP (0.049 g) was added as a terminal terminator and stirred for sufficient mixing. A bisphenol Z solution was prepared by a method including: preparing 419 mL of 0.2N aqueous sodium hydroxide (3.6 g of sodium hydroxide); cooling the solution at the room temperature or less; adding 0.1 g of hydrosulphite as an antioxidant and 5.97 g of bisphenol Z; and completely dissolving the mixed solution. After an inner temperature of the reactor was cooled down to 15 degrees C., all amount of the bisphenol Z solution separately prepared as described above was added to the above solution. 0.059 mL of a tributhylbenzyl ammonium chloride aqueous solution (7 vol %) was added with stirring and the stirring was continued for one hour, so that a reaction mixture was obtained. The obtained reaction mixture was diluted with 0.2 L of methylene chloride and 0.1 L of water to be washed. A lower layer of the reaction mixture was separated. The reaction mixture was further washed with 0.1 L of water one time, with 0.1 L of 0.03N hydrochloric acid one time, and with 0.1 L of water three times in this order. The obtained methylene chloride solution was dropped into methanol with stirring. The obtained redeposit was filtered and dried to obtain a polyarylate resin (PA1) having the following structure.

The polyarylate resin (PA1) was identified as a polyarylate resin having 1.10 dL/g of a reduced viscosity [η_{SP}/C] and a structure with the following repeating unit by the ¹H-NMR spectroscopy and ¹³C-NMR spectroscopy.

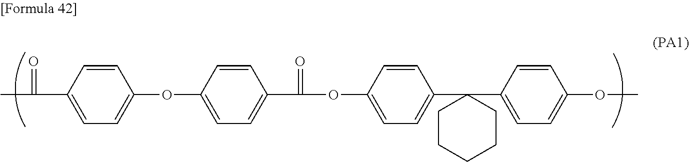

The main resin (PC1-4) and blend resin (PA1) described above were mixed at a mass ratio of PC1-4:PA1=90 parts by mass:10 parts by mass to obtain a resin composition (1H).

An electrophotographic photoreceptor was manufactured in the same manner as in Example 1 except that the resin composition (1H) was used in place of the resin composition (1 A).

### Comparative 1

The PC1-1 resin was used alone as a resin of Comparative 1 (resin composition (2A)). An electrophotographic photoreceptor was manufactured in the same manner as in Example 1 except that the resin composition (2A) was used in place of the resin composition (1A).

### Comparative 2

The PC1-2 resin was used alone as a resin of Comparative 2 (resin composition (2B)). An electrophotographic photoreceptor was manufactured in the same manner as in Example 1 except that the resin composition (2B) was used in place of the resin composition (1A).

### Comparative 3

The PC2-1 resin was used alone as a resin of Comparative 3 (resin composition (2C)). An electrophotographic photoreceptor was manufactured in the same manner as in Example 2 except that the resin composition (2C) was used in place of the resin composition (1A).

### Comparative 4

The PC2-2 resin was used alone as a resin of Comparative 4 (resin composition (2D)). An electrophotographic photoreceptor was manufactured in the same manner as in Example 2 except that the resin composition (2D) was used in place of the resin composition (1A).

### Comparative 5

The PC1-4 resin was used alone as a resin of Comparative 5 (resin composition (2E)). An electrophotographic photoreceptor was manufactured in the same manner as in Example 2 except that the resin composition (2E) was used in place of the resin composition (1A).

### Comparative 6

The PC1-5 resin was used alone as a resin of Comparative 6 (resin composition (2F)). An electrophotographic photoreceptor was manufactured in the same manner as in Example 2 except that the resin composition (2F) was used in place of the resin composition (1A).

### Comparative 7

The PA1 resin was used alone as a resin of Comparative 7 (resin composition (2G)). An electrophotographic photoreceptor was manufactured in the same manner as in Example 2 except that the resin composition (2G) was used in place of the resin composition (1A).

### Comparative 8

### Synthesis of Main Resin

PC1-1 was synthesized by the same method as in Example 1.

### Synthesis of Blend Resin

Z-CF (172.0 mL) of Manufacturing Example 4 and methylene chloride (250 mL) were put into a reactor provided with a mechanical stirrer, stirring vane and baffle plate. To this solution, PTBP (0.318 g) was added as a terminal terminator and stirred for sufficient mixing. A dihydric phenol solution was prepared by a method including: preparing 140 mL of 1.8N aqueous potassium hydroxide (23.0 g of potassium hydroxide); after cooling the solution at the room temperature or less, adding 0.1 g of hydrosulphite as an antioxidant and 26.3 g of 1,1-bis(4-hydroxyphenyl)cyclohexane (bisphenol Z) to the solution; and completely dissolving the mixed solution. After an inner temperature of the reactor was cooled down to 15 degrees C. after the above stirring, all amount of the dihydric phenol solution separately prepared as described above was added to the above solution. 1.0 mL of a triethylamine aqueous solution (7 vol %) was added with stirring and the stirring was continued for one hour, so that a reaction mixture was obtained.

The obtained reaction mixture was diluted with 0.5 L of methylene chloride and 0.1 L of water to be washed. A lower layer of the reaction mixture was separated. The reaction mixture was further washed with 0.1 L of water one time, with 0.1 L of 0.03N hydrochloric acid one time, and with 0.1 L of water three times in this order. The obtained methylene chloride solution was dropped into methanol with stirring. The obtained redeposit was filtered and dried to obtain a PC resin (PC2-3).

The PC resin (PC2-3) was identified as a PC copolymer having 1.16 dL/g of a reduced viscosity [η_{SP}/C] and a structure with the following repeating unit by the ¹H-NMR spectroscopy.

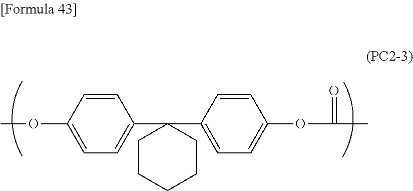

The main resin (PC1-1) and blend resin (PC2-3) described above were mixed at a mass ratio of PC1-1:PC2−3=90 parts by mass:10 parts by mass to obtain a resin composition (2H).

An electrophotographic photoreceptor was manufactured in the same manner as in Example 2 except that the resin composition (2H) was used in place of the resin composition (1 A).

The resin compositions and the electrophotographic photoreceptors of Examples 1-8 and Comparatives 1-8 were evaluated as follows.

Evaluation on Wear Resistance of Resin Compositions and Electrophotographic Photoreceptors

Wear resistance of the resin compositions and the electrophotographic photoreceptors was evaluated as follows.

### (1) Sample Preparation for Evaluation on Wear Resistance of Each Resin Composition:

Each resin composition (2 g) was dissolved in methylene chloride (12 mL) and the obtained solution was cast into film on a commercially available PET film using an applicator. This film was heated under reduced pressure and a solvent was removed to obtain a film sample having a thickness of about 30 μm.

### (2) Sample Preparation for Evaluation on Wear Resistance of Each Electrophotographic Photoreceptor:

Each resin composition (1 g) and the compound (1 g) represented by the formula (CTM-1) were dissolved in methylene chloride (10 mL) and the obtained solution was cast into film on a commercially available PET film using an applicator. This film was heated under reduced pressure and a solvent was removed to obtain a film sample having a thickness of about 30 μm.

### (3) Evaluation:

Wear resistance of cast surfaces of the films manufactured at (1) and (2) process was evaluated using a Suga wear test instrument NUS-ISO-3 model (manufactured by Suga Test Instruments Co., Ltd.). Test was conducted under conditions that an abrasion paper having an alumina particle with a particle size of 3 μm was given a 9.8-N load, the sample was put into reciprocating motion 2000 times on the abrasion paper in contact with a surface of a photosensitive layer, and a mass reduction (wear amount) of the sample was measured. The results are shown in Table 1.

### Evaluation on Electrophotographic Characteristics of Electrophotographic Photoreceptor

Next, electrophotographic characteristics of each of the above-obtained electrophotographic photoreceptors attached to the aluminum drum were evaluated at 700 V of an initial charge amount in the EV mode using an electrostatic charging tester CYNTHIA54IM (manufactured by GEN-TECH, INC.). It was observed that each sample generated light attenuation of reducing a surface potential by light radiation and the sample functioned as the photoreceptor. In this evaluation, a potential when no change was observed after a sufficient exposure was evaluated as a “residual potential.”

The residual potential at 50 V or less is marked as A. The residual potential at more than 50 V and equal to or less than 55 V is marked as B. The residual potential at more than 55 V is marked as C. The results are shown in Table 1.

TABLE 1

| | | | | | electrophotographic | |
|---|---|---|---|---|---|---|
| | Resin Composition | | | | photoreceptor | |
| | | | Blend Ratio | Mass Reduction | Mass Reduction | |
| | (1) Main | (2) | (1):(2) | Amount | Amount | Residual |
| | Resin | Blend Resin | parts by mass | (Wear Amount) (mg) | (Wear Amount) (mg) | Potential |
| Example 1 | PC1 - 1 | PC2 - 1 | 90:10 | 0.20 | 0.43 | A |
| Example 2 | PC1 - 1 | PC2 - 2 | 90:10 | 0.21 | 0.45 | A |
| Example 3 | PC1 - 2 | PC2 - 1 | 90:10 | 0.22 | 0.42 | A |
| Example 4 | PC1 - 2 | PC2 - 2 | 90:10 | 0.23 | 0.47 | A |
| Example 5 | PC1 - 3 | PC2 - 1 | 90:10 | 0.21 | 0.43 | A |
| Example 6 | PC1 - 4 | PC2 - 1 | 90:10 | 0.23 | 0.48 | A |
| Example 7 | PC1 - 5 | PC2 - 1 | 90:10 | 0.26 | 0.54 | A |
| Example 8 | PC1 - 4 | PA1 | 90:10 | 0.24 | 0.53 | B |
| Comparative 1 | PC1 - 1 | — | — | 0.25 | 0.57 | B |
| Comparative 2 | PC1 - 2 | — | — | 0.29 | 0.58 | B |
| Comparative 3 | — | PC2 - 1 | — | 0.77 | 1.49 | A |
| Comparative 4 | — | PC2 - 2 | — | 0.58 | 1.26 | A |
| Comparative 5 | PC1 - 4 | — | — | 0.28 | 0.61 | B |
| Comparative 6 | PC1 - 5 | — | — | 0.31 | 0.64 | B |
| Comparative 7 | — | PA1 | — | 0.30 | 0.63 | C |
| Comparative 8 | PC1 - 1 | PC2 - 3 | 90:10 | 0.33 | 0.69 | A |

As shown in Table 1, the resin composition of Example 1 exhibits an improved wear resistance as compared with wear resistance of the resin composition of Comparative 1 (i.e., the main resin of Example 1 used alone) and the resin composition of Comparative 3 (i.e., the blend resin of Example 1 used alone). Moreover, an improvement in wear resistance was observed in: the resin composition of Example 2 as compared with the resin composition of Comparative 1 and the resin composition of Comparative 4; the resin composition of Example 3 as compared with the resin composition of Comparative 2 and the resin composition of Comparative 3: the resin composition of Example 4 as compared with the resin composition of Comparative 2 and the resin composition of Comparative 4; the resin composition of Example 5 as compared with the resin composition of Comparative 3; the resin composition of Example 6 as compared with the resin composition of Comparative 3 and the resin composition of Comparative 5; the resin composition of Example 7 as compared with the resin composition of Comparative 3 and the resin composition of Comparative 6; and the resin composition of Example 8 as compared with the resin composition of Comparative 5 and the resin composition of Comparative 7.

Further, it is found that the electrophotographic photoreceptors of Examples 1 to 8 exhibit an excellent wear resistance and satisfactory electrical characteristics.

1. A resin composition comprising:
a polycarbonate copolymer resin represented by a formula (1); and
a polycarbonate resin having a repeating unit represented by a formula (2), wherein
provided that a total of the polycarbonate copolymer resin represented by the formula (1) and the polycarbonate resin having the repeating unit represented by the formula (2) is defined as 100 parts by mass, a content of the polycarbonate copolymer resin represented by the formula (1) is in a range from 50 parts by mass to 95 parts by mass, 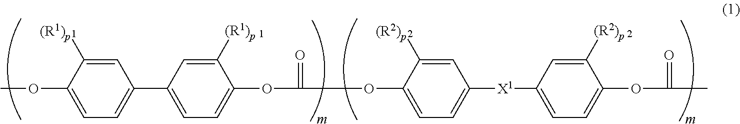
where: m and n each represent an average repeating number of a skeleton unit;
a molar copolymer composition represented by m/(m+n) ranges from 0.4 to 0.67;
X¹ is selected from the group consisting of —O—, —CR³R⁴—, and a substituted or unsubstituted cycloalkylidene group having 5 to 12 carbon atoms;
when a plurality of X¹ are present, the plurality of X¹ are mutually the same group or different groups;
R¹ and R² are each independently an alkyl group having 1 to 3 carbon atoms or perfluoroalkyl group having 1 to 3 carbon atoms;
a plurality of R¹ are mutually the same group or different groups;
when a plurality of R² are present, the plurality of R² are mutually the same group or different groups;
R³ and R⁴ are each independently selected from the group consisting of a hydrogen atom, an alkyl group having 1 to 12 carbon atoms, and a trifluoromethyl group;
when a plurality of R³ are present, the plurality of R³ are mutually the same group or different groups;
when a plurality of R⁴ are present, the plurality of R⁴ are mutually the same group or different groups;
p¹ is 1 or 2;
a plurality of p¹ are mutually the same or different;
p² is an integer of 0 to 2; and
a plurality of p² are mutually the same or different, 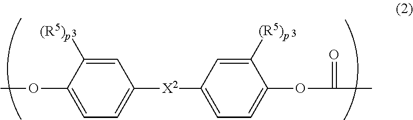
where: X² is —CR⁶R—;
R⁵ is an alkyl group having 1 to 3 carbon atoms;
when a plurality of R⁵ are present, the plurality of R⁵ are mutually the same group or different groups;
R⁶ and R⁷ are each independently selected from the group consisting of a hydrogen atom, an alkyl group having 1 to 12 carbon atoms, a trifluoromethyl group, and a substituted or unsubstituted aryl group having 6 to 12 ring carbon atoms; and
p³ is an integer of 0 to 2; and
a plurality of p³ are mutually the same or different.

2. The resin composition according to claim 1, wherein
provided that the total of the polycarbonate copolymer resin represented by the formula (1) and the polycarbonate resin having the repeating unit represented by the formula (2) is defined as 100 parts by mass, the content of the polycarbonate copolymer resin represented by the formula (1) is in a range from 70 parts by mass to 95 parts by mass.

3. The resin composition according to claim 1, wherein
the polycarbonate resin having the repeating unit represented by the formula (2) is a polycarbonate copolymer resin represented by a formula (20), 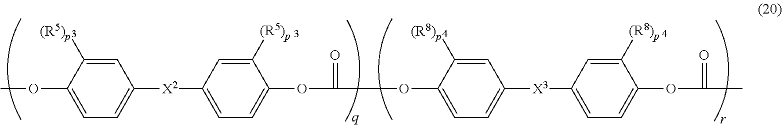
where: q and r each represent an average repeating number of a skeleton unit;
a molar copolymer composition represented by q/(q+r) ranges from 0.1 to 0.9;
X², R⁵ and p³ respectively represent the same as X², R⁵ and p³ in the formula (2);
when a plurality of X² are present, the plurality of X² are mutually the same group or different groups;
X³ is a single bond or —O—;
when a plurality of X³ are present, the plurality of X³ are mutually the same or different;
R⁸ is an alkyl group having 1 to 3 carbon atoms;
when a plurality of R⁸ are present, the plurality of R⁸ are mutually the same group or different groups;
p⁴ is an integer of 0 to 2; and
a plurality of p⁴ are mutually the same or different.

4. A resin composition comprising:
a polycarbonate copolymer resin represented by a formula (1); and
a polyarylate resin having a repeating unit represented by a formula (3), wherein
provided that a total of the polycarbonate copolymer resin represented by the formula (1) and the polyarylate resin having the repeating unit represented by the formula (3) is defined as 100 parts by mass, a content of the polycarbonate copolymer resin represented by the formula (1) is in a range from 50 parts by mass to 95 parts by mass, 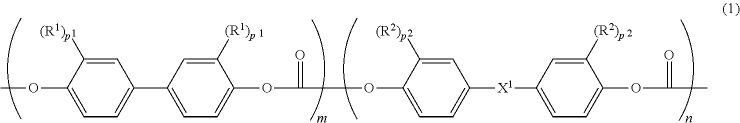
where: m and n each represent an average repeating number of a skeleton unit;
a molar copolymer composition represented by m/(m+n) ranges from 0.4 to 0.67;
X¹ is selected from the group consisting of —O—, —CR³R⁴—, and a substituted or unsubstituted cycloalkylidene group having 5 to 12 carbon atoms;
when a plurality of X¹ are present, the plurality of X¹ are mutually the same group or different groups;
R¹ and R² are each independently an alkyl group having 1 to 3 carbon atoms or perfluoroalkyl group having 1 to 3 carbon atoms;
a plurality of R¹ are mutually the same group or different groups;
when a plurality of R² are present, the plurality of R² are mutually the same group or different groups;
R³ and R⁴ are each independently selected from the group consisting of a hydrogen atom, an alkyl group having 1 to 12 carbon atoms, and a trifluoromethyl group;
when a plurality of R³ are present, the plurality of R³ are mutually the same group or different groups;
when a plurality of R⁴ are present, the plurality of R⁴ are mutually the same group or different groups;
p¹ is 1 or 2;
a plurality of p¹ are mutually the same or different;
p² is an integer of 0 to 2; and
a plurality of p² are mutually the same or different, 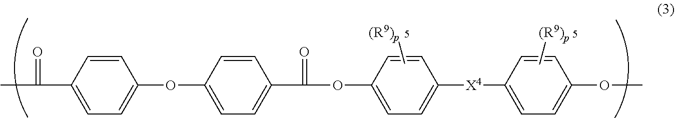
where: X⁴ is selected from the group consisting of a single bond, —CR¹⁰R¹¹—, and a substituted or unsubstituted cycloalkylidene group having 5 to 12 carbon atoms;
R⁹ is an alkyl group having 1 to 3 carbon atoms; when a plurality of R⁹ are present, the plurality of R⁹ are mutually the same group or different groups;
R¹⁰ and R¹¹ are each independently selected from the group consisting of a hydrogen atom, an alkyl group having 1 to 12 carbon atoms, a trifluoromethyl group, and a substituted or unsubstituted aryl group having 6 to 12 ring carbon atoms;
p⁵ is an integer of 0 to 2;
a plurality of p⁵ are mutually the same or different.

5. The resin composition according to claim 4, wherein
provided that the total of the polycarbonate copolymer resin represented by the formula (1) and the polyarylate resin having the repeating unit represented by the formula (3) is defined as 100 parts by mass, the content of the polycarbonate copolymer resin represented by the formula (1) is in a range from 70 parts by mass to 95 parts by mass.

6. The resin composition according to claim 1, wherein
the polycarbonate copolymer resin represented by the formula (1) is one polycarbonate copolymer resin selected from the group consisting of a polycarbonate copolymer resin represented by a formula (1-1), a polycarbonate copolymer resin represented by a formula (1-2), and a polycarbonate copolymer resin represented by a formula (1-3), 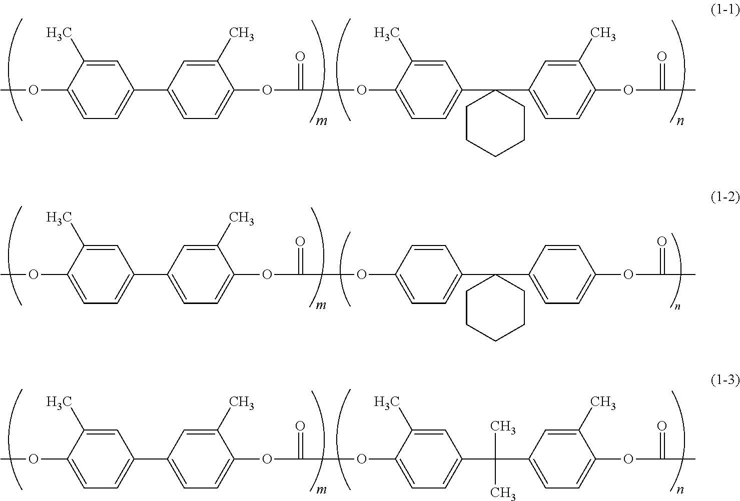
where: m and n respectively represent the same as m and n in the formula (1).

7. An electrophotographic photoreceptor comprising:
a conductive substrate; and
a photosensitive layer formed on the conductive substrate, wherein
the photosensitive layer comprises the resin composition according to claim 1 as a component.

8. The electrophotographic photoreceptor according to claim 7, wherein
the photosensitive layer at least comprises a charge generating agent, a charge transporting agent, and a binder resin, and
the binder resin comprises the resin composition.

9. The electrophotographic photoreceptor according to claim 7, wherein
the photosensitive layer is a multi-layer photosensitive layer sequentially comprising: at least one charge generating layer comprising the charge generating agent; and at least one charge transporting layer comprising the charge transporting agent and the binder resin, or a single-layer photosensitive layer at least comprising the charge generating agent, the charge transporting agent, and the binder resin.

10. An electrophotographic device comprising the electrophotographic photoreceptor according to claim 7.

11. The resin composition according to claim 4, wherein
the polycarbonate copolymer resin represented by the formula (1) is one polycarbonate copolymer resin selected from the group consisting of a polycarbonate copolymer resin represented by a formula (1-1), a polycarbonate copolymer resin represented by a formula (1-2), and a polycarbonate copolymer resin represented by a formula (1-3), 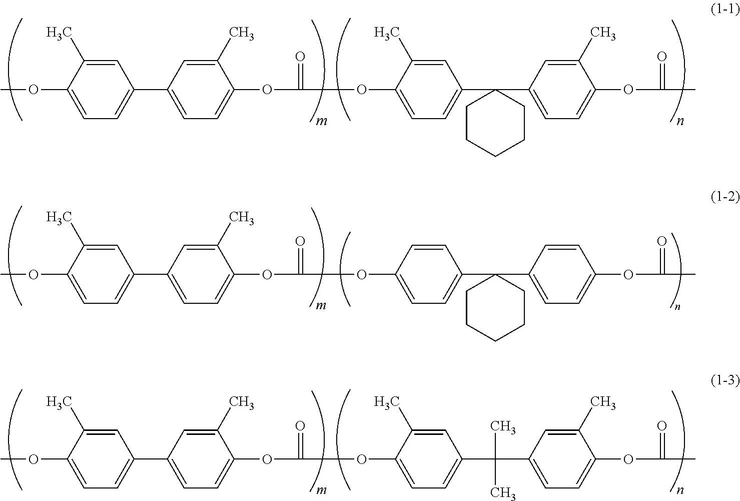
in the formulae (1-1) to (1-3), m and n respectively represent the same as m and n in the formula (1).

12. An electrophotographic photoreceptor comprising:
a conductive substrate; and
a photosensitive layer formed on the conductive substrate, wherein
the photosensitive layer comprises the resin composition according to claim 4 as a component.

13. The electrophotographic photoreceptor according to claim 12, wherein
the photosensitive layer at least comprises a charge generating agent, a charge transporting agent, and a binder resin, and
the binder resin comprises the resin composition.

14. The electrophotographic photoreceptor according to claim 12, wherein
the photosensitive layer is a multi-layer photosensitive layer sequentially comprising: at least one charge generating layer comprising the charge generating agent; and at least one charge transporting layer comprising the charge transporting agent and the binder resin, or a single-layer photosensitive layer at least comprising the charge generating agent, the charge transporting agent, and the binder resin.

15. An electrophotographic device comprising the electrophotographic photoreceptor according to claim 12.
